(19) United States
(12) Patent Application Publication
(10) Pub. No.: US 2021/0142118 A1
(43) Pub. Date: May 13, 2021

(54) AUTOMATED REINFORCEMENT LEARNING BASED CONTENT RECOMMENDATION

(71) Applicant: Pearson Education, Inc., Hoboken, NJ (US)

(72) Inventors: William Vander Lugt, Englewood, CO (US); Theodore Ampian, Englewood, CO (US); Quinn Lathrop, Denver, CO (US)

(21) Appl. No.: 17/079,036

(22) Filed: Oct. 23, 2020

Related U.S. Application Data
(60) Provisional application No. 62/933,897, filed on Nov. 11, 2019.
(60) Provisional application No. 63/068,934, filed on Aug. 21, 2020.

(51) Int. Cl. G06K 9/62; G06N 20/00; G06F 17/16

(52) U.S. Cl. CPC G06K 9/6262; G06K 9/6282; G06F 17/16; G06N 20/00; G06K 9/623

(57) ABSTRACT

Embodiments of the present disclosure relate to systems and methods for reinforcement learning based content recommendation. The method includes receiving configuration data for creation of a reinforcement learning model, generating a plurality of correlation matrices, receiving a request for content for providing to a user, determining a user context, the user context characterizing an aggregation of attributes of the user, and selecting a next piece of content from a database of pieces of content. The method can include presenting the selected piece of content to the user, receiving user inputs in response to the presenting of the selected piece of content to the user, and updating the value characterizing the outcome of previous presentation of the selected piece of content based on the received user input.

### CROSS-REFERENCES TO RELATED APPLICATIONS

This application claims the benefit of U.S. Provisional Application No. 62/933,897, filed on Nov. 11, 2019, and entitled “AUTOMATED HYBRID CONTENT EVALUATION,” and U.S. Provisional Application No. 63/068,934, filed on Aug. 21, 2020, and entitled “AUTOMATED OCR DATABASE GENERATION,” the entirety of each of which is hereby incorporated by reference herein.

### BACKGROUND

A computer network or data network is a telecommunications network which allows computers to exchange data. In computer networks, networked computing devices exchange data with each other along network links (data connections). The connections between nodes are established using either cable media or wireless media. The best-known computer network is the Internet.

Network computer devices that originate, route, and terminate the data are called network nodes. Nodes can include hosts such as personal computers, phones, servers, as well as networking hardware. Two such devices can be said to be networked together when one device is able to exchange information with the other device, whether or not they have a direct connection to each other.

Computer networks differ in the transmission media used to carry their signals, the communications protocols to organize network traffic, the network's size, topology and organizational intent. In most cases, communications protocols are layered on (i.e. work using) other more specific or more general communications protocols, except for the physical layer that directly deals with the transmission media.

### BRIEF SUMMARY

One aspect of the present disclosure relates to a method for reinforcement learning based content recommendation. The method includes receiving configuration data for creation of a reinforcement learning model, the configuration data including a plurality of variables, each of the plurality of variables including a plurality of states. The method includes generating a plurality of correlation matrices. In some embodiments, a correlation matrix is generated for each of at least a portion of the plurality of variables. In some embodiments, the correlation matrix of one of the plurality of variables characterizes a correlation between the plurality of states of that one of the plurality of variables. The method includes receiving a request for content for providing to a user, determining a user context, the user context characterizing an aggregation of attributes of the user, and selecting a next piece of content from a database of pieces of content. In some embodiments, each piece of content is linked with a value characterizing an outcome of previous presentation of that piece of content. In some embodiments, the next piece of content is selected in part based on the value characterizing the outcome of previous presentation and on the user context and the correlation matrices. The method includes presenting the selected piece of content to the user, receiving user inputs in response to the presenting of the selected piece of content to the user, and updating the value characterizing the outcome of previous presentation of the selected piece of content based on the received user input.

In some embodiments, the method further includes receiving a user profile for the user, the user profile containing information defining a plurality of attributes, and determining the user context based on the received user profile. In some embodiments, selecting the next piece of content includes receiving the correlation matrices relevant to the user context, multiplying the received correlation matrices to generate a set of scalar weights, each of which scalar weights is associated with a context, identifying success and failure data for each potential next piece of content in each potential context, multiplying the success and failure data for each potential next piece of content in each potential context by the scalar weight for that context, generating a sum of each of the weighted success data and failure data for each potential next piece of content, and selecting the next piece of content based on the sums. In some embodiments, selecting the next piece of content based on the sums includes selecting one of a list of potential pieces of content for presentation according to a sampling algorithm. In some embodiments, the sampling algorithm can be a Thompson-sampling algorithm. In some embodiments, selecting the next piece of content based on the sums includes: generating rank ordered list of potential pieces of next content; and displaying the rank ordered list of potential pieces of next content to the user.

In some embodiments, generating the plurality of correlation matrices includes selecting one of the plurality of variables, determining a type of the selected one of the plurality of variables, and generating correlation values for the selected one of the plurality of variables based on the type of the selected one of the plurality of variables. In some embodiments, the type of the selected one of the plurality of variables includes at least one of: an ordinal variable; and a hierarchical variable. In some embodiments, when the selected one of the plurality of variables is an ordinal variable, generating correlation values includes identifying states within the selected variable, forming pairs between the states within the selected variable, and generating kernel values for each of the pairs between states within the selected variable. In some embodiments, the method further includes populating a correlation matrix with the kernel values.

In some embodiments, when the selected one of the plurality of variables is a hierarchical variable, generating correlation values includes identifying a hierarchy of states within the selected one of the plurality of variables, receiving correlation values between nodes in all parent levels in the hierarchy of states, calculating leaf node correlations, and populating the correlation matrix with the leaf node correlations. In some embodiments, the leaf node correlations are calculated via path analysis.

One aspect of the present disclosure relates to a system for reinforcement learning based content recommendation. The system can include a memory including a plurality of databases and at least one processor. The at least one processor can receive configuration data for creation of a reinforcement learning model, which configuration data can include a plurality of variables, each of which plurality of variables can include a plurality of states. The at least one processor can generate a plurality of correlation matrices. In some embodiments, a correlation matrix is generated for each of at least a portion of the plurality of variables, and in some embodiments the correlation matrix of one of the plurality of variables characterizes a correlation between the plurality of states of that one of the plurality of variables. The at least one processor can receive a request for content for providing to a user, determine a user context, the user context characterizing an aggregation of attributes of the user, and select a next piece of content from a database of pieces of content. In some embodiments, each piece of content is linked with a value characterizing an outcome of previous presentation of that piece of content, and in some embodiments the next piece of content is selected in part based on the value characterizing the outcome of previous presentation and on the user context and the correlation matrices. The at least one processor can present the selected piece of content to the user, receive user inputs in response to the presenting of the selected piece of content to the user, and update the value characterizing the outcome of previous presentation of the selected piece of content based on the received user input.

In some embodiments, selecting the next piece of content includes receiving the correlation matrices relevant to the user context, multiplying the received correlation matrices to generate a set of scalar weights, each of which scalar weights is associated with a context, identifying success and failure data for each potential next piece of content in each potential context, multiplying the success and failure data for each potential next piece of content in each potential context by the scalar weight for that context, generating a sum of each of the weighted success data and failure data for each potential next piece of content, and selecting the next piece of content based on the sums. In some embodiments, selecting the next piece of content based on the sums includes selecting one of a list of potential pieces of content for presentation according to a sampling algorithm. In some embodiments, the sampling algorithm can be a Thompson-sampling algorithm.

In some embodiments, generating the plurality of correlation matrices includes selecting one of the plurality of variables, determining a type of the selected one of the plurality of variables, and generating correlation values for the selected one of the plurality of variables based on the type of the selected one of the plurality of variables. In some embodiments, the type of the selected one of the plurality of variables includes at least one of: an ordinal variable; and a hierarchical variable.

In some embodiments, when the selected one of the plurality of variables is an ordinal variable, generating correlation values includes identifying states within the selected variable, forming pairs between the states within the selected variable, generating kernel values for each of the pairs between states within the selected variable, and populating a correlation matrix with the kernel values. In some embodiments, when the selected one of the plurality of variables is a hierarchical variable, generating correlation values includes identifying a hierarchy of states within the selected one of the plurality of variables, receiving correlation values between nodes in all parent levels in the hierarchy of states, calculating leaf node correlations, and populating the correlation matrix with the leaf node correlations. In some embodiments, the leaf node correlations are calculated via path analysis.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 is a block diagram illustrating an example of a content distribution network.

FIG. 2 is a block diagram illustrating a computer server and computing environment within a content distribution network.

FIG. 3 is a block diagram illustrating an embodiment of one or more data store servers within a content distribution network.

FIG. 4 is a block diagram illustrating an embodiment of one or more content management servers within a content distribution network.

FIG. 5 is a block diagram illustrating the physical and logical components of a special-purpose computer device within a content distribution network.

FIG. 6 is a block diagram illustrating one embodiment of the communication network.

FIG. 7 is a block diagram illustrating one embodiment of user device and supervisor device communication.

FIG. 8 is a schematic illustration of one embodiment of a computing stack.

FIG. 9 is a schematic illustration of one embodiment of communication and processing flow of modules within the content distribution network.

FIG. 10 is a schematic illustration of one embodiment of communication and processing flow of modules within the content distribution network.

FIG. 11 is a schematic illustration of one embodiment of communication and processing flow of modules within the content distribution network.

FIG. 12 is a schematic illustration of one embodiment of communication and processing flow of modules within the content distribution network.

FIG. 13 is a flowchart illustrating one embodiment of a process for data management.

FIG. 14 is a flowchart illustrating one embodiment of a process for evaluating a response.

FIG. 15 is a flowchart illustrating one embodiment of a process for hybrid solution evaluation.

FIG. 16 is a flowchart illustrating one embodiment of a process for rule-based next step generation.

FIG. 17 is a flowchart illustrating one embodiment of a process for automatic conversion of image data into computer readable text.

FIG. 18 is a flowchart illustrating one embodiment of a process for location prediction within a knowledge graph.

FIG. 19 a flowchart illustrating one embodiment of the process for generating a correct next step.

FIG. 20 is a flowchart illustrating one embodiment of a process for automated indeterminate prompt resolution.

FIG. 21 is a flowchart illustrating one embodiment of a process for reinforcement learning-based content recommendation.

FIG. 22 is a flowchart illustrating one embodiment of a process for hybrid solution evaluation.

FIG. 23 is a flowchart illustrating one embodiment of a process for automated content recommendation.

FIG. 24 is a flowchart illustrating one embodiment of a process for performing a configuration step.

FIG. 25 is a flowchart illustrating one embodiment of a process for generating correlation matrices.

FIG. 26 is a flowchart illustrating one embodiment of a process the content recommendation.

FIG. 27 is a schematic illustration of one embodiment of a architecture for performing automated content recommendation.

FIG. 28 is a flowchart illustrating one embodiment of a process for synthetic data creation.

FIG. 29 is a flowchart illustrating one embodiment of a process for expression cleaning.

FIG. 30 is a flowchart illustrating one embodiment of a process for rendering.

FIG. 31 is a flowchart illustrating one embodiment of a process for TFrecord creation.

FIG. 32 is a flowchart illustrating one embodiment of process for OCR training.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides illustrative embodiment(s) only and is not intended to limit the scope, applicability, or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

Education follows the same patterns that have been followed for many millennia. Traditionally, teachers provide instruction to classes of students and control the pace of learning and delivery of content to the students. While in many instances the number of students in a class may be large, in certain instances, especially when tutoring is provided, the number of students instructed by a teacher may shrink to the point that a teacher may provide one-on-one instruction. While one-on-one instruction has several benefits, it has a high cost which makes it inaccessible to many students. Further, even in a one-on-one situation teachers are limited in their ability to understand student problems and to provide appropriate content.

Many have sought to address or mitigate these issues through adaptive learning technologies. These technologies use content recommendation engines and/or evaluation engines to select and provide content to students, and then to evaluate responses received from students. These content recommendation engines and/or evaluation engines provide the ability for many more students to gain access to one-on-one tutoring and thereby accelerate their learning process. However, these current engines have limitations namely, they are limited to the universe of content and questions stored in databases accessible by these engines. Thus, these current engines recommend content already found in databases and evaluate responses to questions provided from those databases.

There may be many reasons why current engines are so closely tied to content already contained in databases accessible to those engines. In many instances, this includes the great difficulties in evaluating responses to problems that are not previously known. The present disclosure includes systems and methods that break this tie to pre-existing content accessible by recommendation and/or evaluation engines. To be clear, the systems and methods of the present disclosure can be used with pre-existing and accessible content, but the systems and methods of the present disclosure can also be used with content not previously found in databases accessible by the recommendation engine and/or the evaluation engine.

Specifically, the systems and methods of the present disclosure can be used to provide an evaluation of the received response that can include multiple steps. This is achieved through the use of a dual evaluation engine, also referred to herein as a math engine. This math engine includes two components, namely, a computer algebra system such as, for example, SimPy—a Python symbolic mathematics library, and a rules-based math engine. The combination of these two components can overcome weaknesses of the computer algebra system such as, for example, an inability or difficulty to generate and/or recommend a next step in the solution of an unknown problem and/or an inability or difficulty to determine if a step in the solution is a final step, or in other words, embodies the final answer to the problem.

The systems and methods of the present disclosure facilitate evaluation of a response to a previously unknown question the other automatic generation of metadata for that response. This can include determining that the response could be an answer to a plurality of questions. For example, a single string of characters such as, y=x²+2x−5−(2(6x−1)), may be used to test a variety of skills. For example, a student may simplify, integrate, or take the derivative of that string of characters. In other words, the response data may be ambiguous. If such ambiguity is determined, then a goal clarification process may be initiated. Through this goal clarification process attributes of the problem associated with the response data may be determined, and metadata for the response data and/or for the associated problem may be generated. This goal clarification process can include interactions with the user via, for example, the user interface of a user device. These metadata generated via the goal clarification process can be provided to the math engine for use in evaluating the received response data.

The use of such a math engine including two components can be facilitated by improvements in OCR technology also disclosed herein. Specifically, disclose OCR technology is able to efficiently and effectively generate computer readable character strings from image data. This is accomplished through a multistep process including the generation of a plurality of: areas; tokens; and confidence scores for the image data. These areas, tokens, and confidence scores can be ingested into a decoder which can generate a computer readable character string, and specifically can generate, a LaTeX character string. This character string can be presented to the user and feedback received from the user can be used to improve this multistep process.

With reference now to FIG. 1, a block diagram is shown illustrating various components of a content distribution network (CDN) 100 which implements and supports certain embodiments and features described herein. In some embodiments, the content distribution network 100 can comprise one or several physical components and/or one or several virtual components such as, for example, one or several cloud computing components. In some embodiments, the content distribution network 100 can comprise a mixture of physical and cloud computing components.

Content distribution network 100 may include one or more content management servers 102. As discussed below in more detail, content management servers 102 may be any desired type of server including, for example, a rack server, a tower server, a miniature server, a blade server, a mini rack server, a mobile server, an ultra-dense server, a super server, or the like, and may include various hardware components, for example, a motherboard, a processing unit, memory systems, hard drives, network interfaces, power supplies, etc. Content management server 102 may include one or more server farms, clusters, or any other appropriate arrangement and/or combination or computer servers. Content management server 102 may act according to stored instructions located in a memory subsystem of the server 102, and may run an operating system, including any commercially available server operating system and/or any other operating systems discussed herein.

The content distribution network 100 may include one or more data store servers 104, such as database servers and file-based storage systems. The database servers 104 can access data that can be stored on a variety of hardware components. These hardware components can include, for example, components forming tier 0 storage, components forming tier 1 storage, components forming tier 2 storage, and/or any other tier of storage. In some embodiments, tier 0 storage refers to storage that is the fastest tier of storage in the database server 104, and particularly, the tier 0 storage is the fastest storage that is not RAM or cache memory. In some embodiments, the tier 0 memory can be embodied in solid state memory such as, for example, a solid-state drive (SSD) and/or flash memory.

In some embodiments, the tier 1 storage refers to storage that is one or several higher performing systems in the memory management system, and that is relatively slower than tier 0 memory, and relatively faster than other tiers of memory. The tier 1 memory can be one or several hard disks that can be, for example, high-performance hard disks. These hard disks can be one or both of physically or communicatively connected such as, for example, by one or several fiber channels. In some embodiments, the one or several disks can be arranged into a disk storage system, and specifically can be arranged into an enterprise class disk storage system. The disk storage system can include any desired level of redundancy to protect data stored therein, and in one embodiment, the disk storage system can be made with grid architecture that creates parallelism for uniform allocation of system resources and balanced data distribution.

In some embodiments, the tier 2 storage refers to storage that includes one or several relatively lower performing systems in the memory management system, as compared to the tier 1 and tier 2 storages. Thus, tier 2 memory is relatively slower than tier 1 and tier 0 memories. Tier 2 memory can include one or several SATA-drives (e.g., Serial AT Attachment drives) or one or several NL-SATA drives.

In some embodiments, the one or several hardware and/or software components of the database server 104 can be arranged into one or several storage area networks (SAN), which one or several storage area networks can be one or several dedicated networks that provide access to data storage, and particularly that provides access to consolidated, block level data storage. A SAN typically has its own network of storage devices that are generally not accessible through the local area network (LAN) by other devices. The SAN allows access to these devices in a manner such that these devices appear to be locally attached to the user device.

Data stores 104 may comprise stored data relevant to the functions of the content distribution network 100. Illustrative examples of data stores 104 that may be maintained in certain embodiments of the content distribution network 100 are described below in reference to FIG. 3. In some embodiments, multiple data stores may reside on a single server 104, either using the same storage components of server 104 or using different physical storage components to assure data security and integrity between data stores. In other embodiments, each data store may have a separate dedicated data store server 104.

Content distribution network 100 also may include one or more user devices 106 and/or supervisor devices 110. User devices 106 and supervisor devices 110 may display content received via the content distribution network 100, and may support various types of user interactions with the content. User devices 106 and supervisor devices 110 may include mobile devices such as smartphones, tablet computers, personal digital assistants, and wearable computing devices. Such mobile devices may run a variety of mobile operating systems and may be enabled for Internet, e-mail, short message service (SMS), Bluetooth®, mobile radio-frequency identification (M-RFID), and/or other communication protocols. Other user devices 106 and supervisor devices 110 may be general purpose personal computers or special-purpose computing devices including, by way of example, personal computers, laptop computers, workstation computers, projection devices, and interactive room display systems. Additionally, user devices 106 and supervisor devices 110 may be any other electronic devices, such as a thin-client computers, an Internet-enabled gaming systems, business or home appliances, and/or a personal messaging devices, capable of communicating over network(s) 120.

In different contexts of content distribution networks 100, user devices 106 and supervisor devices 110 may correspond to different types of specialized devices, for example, student devices and teacher devices in an educational network, employee devices and presentation devices in a company network, different gaming devices in a gaming network, etc.

In some embodiments, user devices 106 and supervisor devices 110 may operate in the same physical location 107, such as a classroom or conference room. In such cases, the devices may contain components that support direct communications with other nearby devices, such as wireless transceivers and wireless communications interfaces, Ethernet sockets or other Local Area Network (LAN) interfaces, etc. In other implementations, the user devices 106 and supervisor devices 110 need not be used at the same location 107, but may be used in remote geographic locations in which each user device 106 and supervisor device 110 may use security features and/or specialized hardware (e.g., hardware-accelerated SSL and HTTPS, WS-Security, firewalls, etc.) to communicate with the content management server 102 and/or other remotely located user devices 106. Additionally, different user devices 106 and supervisor devices 110 may be assigned different designated roles, such as presenter devices, teacher devices, administrator devices, or the like, and in such cases the different devices may be provided with additional hardware and/or software components to provide content and support user capabilities not available to the other devices.

The content distribution network 100 also may include a privacy server 108 that maintains private user information at the privacy server 108 while using applications or services hosted on other servers. For example, the privacy server 108 may be used to maintain private data of a user within one jurisdiction even though the user is accessing an application hosted on a server (e.g., the content management server 102) located outside the jurisdiction. In such cases, the privacy server 108 may intercept communications between a user device 106 or supervisor device 110 and other devices that include private user information. The privacy server 108 may create a token or identifier that does not disclose the private information and may use the token or identifier when communicating with the other servers and systems, instead of using the user's private information.

As illustrated in FIG. 1, the content management server 102 may be in communication with one or more additional servers, such as a content server 112, a user data server 114, and/or an administrator server 116. Each of these servers may include some or all of the same physical and logical components as the content management server(s) 102, and in some cases, the hardware and software components of these servers 112-116 may be incorporated into the content management server(s) 102, rather than being implemented as separate computer servers.

Content server 112 may include hardware and software components to generate, store, and maintain the content resources for distribution to user devices 106 and other devices in the network 100. For example, in content distribution networks 100 used for professional training and educational purposes, content server 112 may include data stores of training materials, presentations, plans, syllabi, reviews, evaluations, interactive programs and simulations, course models, course outlines, and various training interfaces that correspond to different materials and/or different types of user devices 106. In content distribution networks 100 used for media distribution, interactive gaming, and the like, a content server 112 may include media content files such as music, movies, television programming, games, and advertisements.

User data server 114 may include hardware and software components that store and process data for multiple users relating to each user's activities and usage of the content distribution network 100. For example, the content management server 102 may record and track each user's system usage, including their user device 106, content resources accessed, and interactions with other user devices 106. This data may be stored and processed by the user data server 114, to support user tracking and analysis features. For instance, in the professional training and educational contexts, the user data server 114 may store and analyze each user's training materials viewed, presentations attended, courses completed, interactions, evaluation results, and the like. The user data server 114 may also include a repository for user-generated material, such as evaluations and tests completed by users, and documents and assignments prepared by users. In the context of media distribution and interactive gaming, the user data server 114 may store and process resource access data for multiple users (e.g., content titles accessed, access times, data usage amounts, gaming histories, user devices and device types, etc.).

Administrator server 116 may include hardware and software components to initiate various administrative functions at the content management server 102 and other components within the content distribution network 100. For example, the administrator server 116 may monitor device status and performance for the various servers, data stores, and/or user devices 106 in the content distribution network 100. When necessary, the administrator server 116 may add or remove devices from the network 100, and perform device maintenance such as providing software updates to the devices in the network 100. Various administrative tools on the administrator server 116 may allow authorized users to set user access permissions to various content resources, monitor resource usage by users and devices 106, and perform analyses and generate reports on specific network users and/or devices (e.g., resource usage tracking reports, training evaluations, etc.).

The content distribution network 100 may include one or more communication networks 120. Although only a single network 120 is identified in FIG. 1, the content distribution network 100 may include any number of different communication networks between any of the computer servers and devices shown in FIG. 1 and/or other devices described herein. Communication networks 120 may enable communication between the various computing devices, servers, and other components of the content distribution network 100. As discussed below, various implementations of content distribution networks 100 may employ different types of networks 120, for example, computer networks, telecommunications networks, wireless networks, and/or any combination of these and/or other networks.

The content distribution network 100 may include one or several navigation systems or features including, for example, the Global Positioning System (“GPS”), GALILEO (e.g., Europe's global positioning system), or the like, or location systems or features including, for example, one or several transceivers that can determine location of the one or several components of the content distribution network 100 via, for example, triangulation. All of these are depicted as navigation system 122.

In some embodiments, navigation system 122 can include or several features that can communicate with one or several components of the content distribution network 100 including, for example, with one or several of the user devices 106 and/or with one or several of the supervisor devices 110. In some embodiments, this communication can include the transmission of a signal from the navigation system 122 which signal is received by one or several components of the content distribution network 100 and can be used to determine the location of the one or several components of the content distribution network 100.

With reference to FIG. 2, an illustrative distributed computing environment 200 is shown including a computer server 202, four client computing devices 206, and other components that may implement certain embodiments and features described herein. In some embodiments, the server 202 may correspond to the content management server 102 discussed above in FIG. 1, and the client computing devices 206 may correspond to the user devices 106. However, the computing environment 200 illustrated in FIG. 2 may correspond to any other combination of devices and servers configured to implement a client-server model or other distributed computing architecture.

Client devices 206 may be configured to receive and execute client applications over one or more networks 220. Such client applications may be web browser based applications and/or standalone software applications, such as mobile device applications. Server 202 may be communicatively coupled with the client devices 206 via one or more communication networks 220. Client devices 206 may receive client applications from server 202 or from other application providers (e.g., public or private application stores). Server 202 may be configured to run one or more server software applications or services, for example, web-based or cloud-based services, to support content distribution and interaction with client devices 206. Users operating client devices 206 may in turn utilize one or more client applications (e.g., virtual client applications) to interact with server 202 to utilize the services provided by these components.

Various different subsystems and/or components 204 may be implemented on server 202. Users operating the client devices 206 may initiate one or more client applications to use services provided by these subsystems and components. The subsystems and components within the server 202 and client devices 206 may be implemented in hardware, firmware, software, or combinations thereof. Various different system configurations are possible in different distributed computing systems 200 and content distribution networks 100. The embodiment shown in FIG. 2 is thus one example of a distributed computing system and is not intended to be limiting.

Although exemplary computing environment 200 is shown with four client computing devices 206, any number of client computing devices may be supported. Other devices, such as specialized sensor devices, etc., may interact with client devices 206 and/or server 202.

As shown in FIG. 2, various security and integration components 208 may be used to send and manage communications between the server 202 and user devices 206 over one or more communication networks 220. The security and integration components 208 may include separate servers, such as web servers and/or authentication servers, and/or specialized networking components, such as firewalls, routers, gateways, load balancers, and the like. In some cases, the security and integration components 208 may correspond to a set of dedicated hardware and/or software operating at the same physical location and under the control of the same entities as server 202. For example, components 208 may include one or more dedicated web servers and network hardware in a datacenter or a cloud infrastructure. In other examples, the security and integration components 208 may correspond to separate hardware and software components which may be operated at a separate physical location and/or by a separate entity.

Security and integration components 208 may implement various security features for data transmission and storage, such as authenticating users and restricting access to unknown or unauthorized users. In various implementations, security and integration components 208 may provide, for example, a file-based integration scheme or a service-based integration scheme for transmitting data between the various devices in the content distribution network 100. Security and integration components 208 also may use secure data transmission protocols and/or encryption for data transfers, for example, File Transfer Protocol (FTP), Secure File Transfer Protocol (SFTP), and/or Pretty Good Privacy (PGP) encryption.

In some embodiments, one or more web services may be implemented within the security and integration components 208 and/or elsewhere within the content distribution network 100. Such web services, including cross-domain and/or cross-platform web services, may be developed for enterprise use in accordance with various web service standards, such as RESTful web services (i.e., services based on the Representation State Transfer (REST) architectural style and constraints), and/or web services designed in accordance with the Web Service Interoperability (WS-I) guidelines. Some web services may use the Secure Sockets Layer (SSL) or Transport Layer Security (TLS) protocol to provide secure connections between the server 202 and user devices 206. SSL or TLS may use HTTP or HTTPS to provide authentication and confidentiality. In other examples, web services may be implemented using REST over HTTPS with the OAuth open standard for authentication, or using the WS-Security standard which provides for secure SOAP (e.g., Simple Object Access Protocol) messages using Extensible Markup Language (XML) encryption. In other examples, the security and integration components 208 may include specialized hardware for providing secure web services. For example, security and integration components 208 may include secure network appliances having built-in features such as hardware-accelerated SSL and HTTPS, WS-Security, and firewalls. Such specialized hardware may be installed and configured in front of any web servers, so that any external devices may communicate directly with the specialized hardware.

Communication network(s) 220 may be any type of network familiar to those skilled in the art that can support data communications using any of a variety of commercially-available protocols, including without limitation, TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), Bluetooth®, Near Field Communication (NFC), and the like. Merely by way of example, network(s) 220 may be local area networks (LAN), such as one based on Ethernet, Token-Ring, and/or the like. Network(s) 220 also may be wide-area networks, such as the Internet. Networks 220 may include telecommunication networks such as a public switched telephone networks (PSTNs), or virtual networks such as an intranet or an extranet. Infrared and wireless networks (e.g., using the Institute of Electrical and Electronics (IEEE) 802.11 protocol suite or other wireless protocols) also may be included in networks 220.

Computing environment 200 also may include one or more data stores 210 and/or back-end servers 212. In certain examples, the data stores 210 may correspond to data store server(s) 104 discussed above in FIG. 1, and back-end servers 212 may correspond to the various back-end servers 112-116. Data stores 210 and servers 212 may reside in the same datacenter or may operate at a remote location from server 202. In some cases, one or more data stores 210 may reside on a non-transitory storage medium within the server 202. Other data stores 210 and back-end servers 212 may be remote from server 202 and configured to communicate with server 202 via one or more networks 220. In certain embodiments, data stores 210 and back-end servers 212 may reside in a storage-area network (SAN), or may use storage-as-a-service (STaaS) architectural model.

With reference to FIG. 3, an illustrative set of data stores and/or data store servers is shown, corresponding to the data store servers 104 of the content distribution network 100 discussed above in FIG. 1. One or more individual data stores 301-313 may reside in storage on a single computer server 104 (or a single server farm or cluster) under the control of a single entity, may be virtually implemented, or may reside on separate servers operated by different entities and/or at remote locations. In some embodiments, data stores 301-313 may be accessed by the content management server 102 and/or other devices and servers within the network 100 (e.g., user devices 106, supervisor devices 110, administrator servers 116, etc.). Access to one or more of the data stores 301-313 may be limited or denied based on the processes, user credentials, and/or devices attempting to interact with the data store.

The paragraphs below describe examples of specific data stores that may be implemented within some embodiments of a content distribution network 100. It should be understood that the below descriptions of data stores 301-313, including their functionality and types of data stored therein, are illustrative and non-limiting. Data stores server architecture, design, and the execution of specific data stores 301-313 may depend on the context, size, and functional requirements of a content distribution network 100. For example, in content distribution systems 100 used for professional training and educational purposes, separate databases or file-based storage systems may be implemented in data store server(s) 104 to store trainee and/or student data, trainer and/or professor data, training module data and content descriptions, training results, evaluation data, and the like. In contrast, in content distribution systems 100 used for media distribution from content providers to subscribers, separate data stores may be implemented in data stores server(s) 104 to store listings of available content titles and descriptions, content title usage statistics, subscriber profiles, account data, payment data, network usage statistics, etc.

A user profile data store 301, also referred to herein as a user profile database 301, may include information relating to the end users within the content distribution network 100. This information may include user characteristics such as the user names, access credentials (e.g., logins and passwords), user preferences, and information relating to any previous user interactions within the content distribution network 100 (e.g., requested content, posted content, content modules completed, training scores or evaluations, other associated users, etc.). In some embodiments, this information can relate to one or several individual end users such as, for example, one or several students, teachers, administrators, or the like, and in some embodiments, this information can relate to one or several institutional end users such as, for example, one or several schools, groups of schools such as one or several school districts, one or several colleges, one or several universities, one or several training providers, or the like. In some embodiments, this information can identify one or several user memberships in one or several groups such as, for example, a student's membership in a university, school, program, grade, course, class, or the like.

The user profile database 301 can include information relating to a user's status, location, or the like. This information can identify, for example, a device a user is using, the location of that device, or the like. In some embodiments, this information can be generated based on any location detection technology including, for example, a navigation system 122, or the like.

Information relating to the user's status can identify, for example, logged-in status information that can indicate whether the user is presently logged-in to the content distribution network 100 and/or whether the log-in is active. In some embodiments, the information relating to the user's status can identify whether the user is currently accessing content and/or participating in an activity from the content distribution network 100.

In some embodiments, information relating to the user's status can identify, for example, one or several attributes of the user's interaction with the content distribution network 100, and/or content distributed by the content distribution network 100. This can include data identifying the user's interactions with the content distribution network 100, the content consumed by the user through the content distribution network 100, or the like. In some embodiments, this can include data identifying the type of information accessed through the content distribution network 100 and/or the type of activity performed by the user via the content distribution network 100, the lapsed time since the last time the user accessed content and/or participated in an activity from the content distribution network 100, or the like. In some embodiments, this information can relate to a content program comprising an aggregate of data, content, and/or activities, and can identify, for example, progress through the content program, or through the aggregate of data, content, and/or activities forming the content program. In some embodiments, this information can track, for example, the amount of time since participation in and/or completion of one or several types of activities, the amount of time since communication with one or several supervisors and/or supervisor devices 110, or the like.

In some embodiments in which the one or several end users are individuals, and specifically are students, the user profile database 301 can further include information relating to these students' academic and/or educational history. This information can identify one or several courses of study that the student has initiated, completed, and/or partially completed, as well as grades received in those courses of study. In some embodiments, the student's academic and/or educational history can further include information identifying student performance on one or several tests, quizzes, and/or assignments. In some embodiments, this information can be stored in a tier of memory that is not the fastest memory in the content delivery network 100. In some embodiments, this can comprise response information such as, for example, information identifying one or several questions or pieces of content and responses provided to the same. In some embodiments, this response information can be formed into one or several matrices “D” containing information for n users responding top items, these one or several matrices D are also referred to herein as the matrix D, the D matrix, the user matrix, and/or the response matrix. Thus, the matrix D can have n×p dimensions, and in some embodiments, the matrix D can identify whether user responses to items were correct or incorrect. In some embodiments, for example, the matrix D can include an entry “1” for an item when a user response to that item is correct and can otherwise include and entry “0”.

The user profile database 301 can include information relating to one or several student learning preferences. In some embodiments, for example, the user, also referred to herein as the student or the student-user, may have one or several preferred learning styles, one or several most effective learning styles, and/or the like. In some embodiments, the user's learning style can be any learning style describing how the user best learns or how the user prefers to learn. In one embodiment, these learning styles can include, for example, identification of the user as an auditory learner, as a visual learner, and/or as a tactile learner. In some embodiments, the data identifying one or several user learning styles can include data identifying a learning style based on the user's educational history such as, for example, identifying a user as an auditory learner when the user has received significantly higher grades and/or scores on assignments and/or in courses favorable to auditory learners. In some embodiments, this information can be stored in a tier of memory that is not the fastest memory in the content delivery network 100.

In some embodiments, the user profile data store 301 can further include information identifying one or several user skill levels. In some embodiments, these one or several user skill levels can identify a skill level determined based on past performance by the user interacting with the content delivery network 100, and in some embodiments, these one or several user skill levels can identify a predicted skill level determined based on past performance by the user interacting with the content delivery network 100 and one or several predictive models.

The user profile database 301 can further include information relating to one or several teachers and/or instructors who are responsible for organizing, presenting, and/or managing the presentation of information to the user. In some embodiments, user profile database 301 can include information identifying courses and/or subjects that have been taught by the teacher, data identifying courses and/or subjects currently taught by the teacher, and/or data identifying courses and/or subjects that will be taught by the teacher. In some embodiments, this can include information relating to one or several teaching styles of one or several teachers. In some embodiments, the user profile database 301 can further include information indicating past evaluations and/or evaluation reports received by the teacher. In some embodiments, the user profile database 301 can further include information relating to improvement suggestions received by the teacher, training received by the teacher, continuing education received by the teacher, and/or the like. In some embodiments, this information can be stored in a tier of memory that is not the fastest memory in the content delivery network 100.

An accounts data store 302, also referred to herein as an accounts database 302, may generate and store account data for different users in various roles within the content distribution network 100. For example, accounts may be created in an accounts data store 302 for individual end users, supervisors, administrator users, and entities such as companies or educational institutions. Account data may include account types, current account status, account characteristics, and any parameters, limits, restrictions associated with the accounts.

A content library data store 303, also referred to herein as a content library database 303, may include information describing the individual content items (or content resources or data packets or problems or questions) available via the content distribution network 100. In some embodiments, these data packets in the content library database 303 can be linked to from an object network, or specifically to form a Bayes Net content network or learning graph. In some embodiments, these data packets can be linked in the object network according to one or several prerequisite relationships that can, for example, identify the relative hierarchy and/or difficulty of the data objects. In some embodiments, this hierarchy of data objects can be generated by the content distribution network 100 according to user experience with the object network, and in some embodiments, this hierarchy of data objects can be generated based on one or several existing and/or external hierarchies such as, for example, a syllabus, a table of contents, or the like. In some embodiments, for example, the object network can correspond to a syllabus such that content for the syllabus is embodied in the object network.

In some embodiments, the content library data store 303 can comprise a syllabus, a schedule, or the like. In some embodiments, the syllabus or schedule can identify one or several tasks and/or events relevant to the user. In some embodiments, for example, when the user is a member of a group such as, a section or a class, these tasks and/or events relevant to the user can identify one or several assignments, quizzes, exams, or the like.

In some embodiments, the library data store 303 may include metadata, properties, and other characteristics associated with the content resources stored in the content server 112. Such data may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some embodiments, the library data store 303 may be configured to allow updating of content metadata or properties, and to allow the addition and/or removal of information relating to the content resources. For example, content relationships may be implemented as graph structures, which may be stored in the library data store 303 or in an additional store for use by selection algorithms along with the other metadata.

In some embodiments, the content library data store 303 can contain information used in evaluating responses received from users. In some embodiments, for example, a user can receive content from the content distribution network 100 and can, subsequent to receiving that content, provide a response to the received content. In some embodiments, for example, the received content can comprise one or several questions, prompts, or the like, and the response to the received content can comprise an answer to those one or several questions, prompts, or the like. In some embodiments, information, referred to herein as “comparative data,” from the content library data store 303 can be used to determine whether the responses are the correct and/or desired responses.

In some embodiments, the content library database 303 and/or the user profile database 301 can comprise an aggregation network also referred to herein as a content network or content aggregation network. The aggregation network can comprise a plurality of content aggregations that can be linked together by, for example: creation by common user; relation to a common subject, topic, skill, or the like; creation from a common set of source material such as source data packets; or the like. In some embodiments, the content aggregation can comprise a grouping of content comprising the presentation portion that can be provided to the user in the form of, for example, a flash card and an extraction portion that can comprise the desired response to the presentation portion such as for example, an answer to a flash card. In some embodiments, one or several content aggregations can be generated by the content distribution network 100 and can be related to one or several data packets they can be, for example, organized in object network. In some embodiments, the one or several content aggregations can be each created from content stored in one or several of the data packets.

In some embodiments, the content aggregations located in the content library database 303 and/or the user profile database 301 can be associated with a user-creator of those content aggregations. In some embodiments, access to content aggregations can vary based on, for example, whether a user created the content aggregations. In some embodiments, the content library database 303 and/or the user profile database 301 can comprise a database of content aggregations associated with a specific user, and in some embodiments, the content library database 303 and/or the user profile database 301 can comprise a plurality of databases of content aggregations that are each associated with a specific user. In some embodiments, these databases of content aggregations can include content aggregations created by their specific user and in some embodiments, these databases of content aggregations can further include content aggregations selected for inclusion by their specific user and/or a supervisor of that specific user. In some embodiments, these content aggregations can be arranged and/or linked in a hierarchical relationship similar to the data packets in the object network and/or linked to the object network in the object network or the tasks or skills associated with the data packets in the object network or the syllabus or schedule.

In some embodiments, the content aggregation network, and the content aggregations forming the content aggregation network, can be organized according to the object network and/or the hierarchical relationships embodied in the object network. In some embodiments, the content aggregation network, and/or the content aggregations forming the content aggregation network, can be organized according to one or several tasks identified in the syllabus, schedule or the like.

A pricing data store 304 may include pricing information and/or pricing structures for determining payment amounts for providing access to the content distribution network 100 and/or the individual content resources within the network 100. In some cases, pricing may be determined based on a user's access to the content distribution network 100, for example, a time-based subscription fee or pricing based on network usage. In other cases, pricing may be tied to specific content resources. Certain content resources may have associated pricing information, whereas other pricing determinations may be based on the resources accessed, the profiles and/or accounts of the user, and the desired level of access (e.g., duration of access, network speed, etc.). Additionally, the pricing data store 304 may include information relating to compilation pricing for groups of content resources, such as group prices and/or price structures for groupings of resources.

A license data store 305 may include information relating to licenses and/or licensing of the content resources within the content distribution network 100. For example, the license data store 305 may identify licenses and licensing terms for individual content resources and/or compilations of content resources in the content server 112, the rights holders for the content resources, and/or common or large-scale right holder information such as contact information for rights holders of content not included in the content server 112.

A content access data store 306 may include access rights and security information for the content distribution network 100 and specific content resources. For example, the content access data store 306 may include login information (e.g., user identifiers, logins, passwords, etc.) that can be verified during user login attempts to the network 100. The content access data store 306 also may be used to store assigned user roles and/or user levels of access. For example, a user's access level may correspond to the sets of content resources and/or the client or server applications that the user is permitted to access. Certain users may be permitted or denied access to certain applications and resources based on their subscription level, training program, course/grade level, etc. Certain users may have supervisory access over one or more end users, allowing the supervisor to access all or portions of the end user's content, activities, evaluations, etc. Additionally, certain users may have administrative access over some users and/or some applications in the content management network 100, allowing such users to add and remove user accounts, modify user access permissions, perform maintenance updates on software and servers, etc.

A source data store 307 may include information relating to the source of the content resources available via the content distribution network. For example, a source data store 307 may identify the authors and originating devices of content resources, previous pieces of data and/or groups of data originating from the same authors or originating devices and the like.

An evaluation data store 308 may include information used to direct the evaluation of users and content resources in the content management network 100. In some embodiments, the evaluation data store 308 may contain, for example, the analysis criteria and the analysis guidelines for evaluating users (e.g., trainees/students, gaming users, media content consumers, etc.) and/or for evaluating the content resources in the network 100. The evaluation data store 308 also may include information relating to evaluation processing tasks, for example, the identification of users and user devices 106 that have received certain content resources or accessed certain applications, the status of evaluations or evaluation histories for content resources, users, or applications, and the like. Evaluation criteria may be stored in the evaluation data store 308 including data and/or instructions in the form of one or several electronic rubrics or scoring guides for use in the evaluation of the content, users, or applications. The evaluation data store 308 also may include past evaluations and/or evaluation analyses for users, content, and applications, including relative rankings, characterizations, explanations, and the like.

A model data store 309, also referred to herein as a model database 309 can store information relating to one or several predictive models. In some embodiments, these can include one or several evidence models, risk models, skill models, or the like. In some embodiments, an evidence model can be a mathematically-based statistical model. The evidence model can be based on, for example, Item Response Theory (IRT), Bayesian Network (Bayes net), Performance Factor Analysis (PFA), or the like. The evidence model can, in some embodiments, be customizable to a user and/or to one or several content items. Specifically, one or several inputs relating to the user and/or to one or several content items can be inserted into the evidence model. These inputs can include, for example, one or several measures of user skill level, one or several measures of content item difficulty and/or skill level, or the like. The customized evidence model can then be used to predict the likelihood of the user providing desired or undesired responses to one or several of the content items.

In some embodiments, the risk models can include one or several models that can be used to calculate one or several model function values. In some embodiments, these one or several model function values can be used to calculate a risk probability, which risk probability can characterize the risk of a student-user failing to achieve a desired outcome such as, for example, failing to correctly respond to one or several data packets, failure to achieve a desired level of completion of a program, for example in a pre-defined time period, failure to achieve a desired learning outcome, or the like. In some embodiments, the risk probability can identify the risk of the student-user failing to complete 60% of the program.

In some embodiments, these models can include a plurality of model functions including, for example, a first model function, a second model function, a third model function, and a fourth model function. In some embodiments, some or all of the model functions can be associated with a portion of the program such as, for example a completion stage and/or completion status of the program. In one embodiment, for example, the first model function can be associated with a first completion status, the second model function can be associated with a second completion status, the third model function can be associated with a third completion status, and the fourth model function can be associated with a fourth completion status. In some embodiments, these completion statuses can be selected such that some or all of these completion statuses are less than the desired level of completion of the program. Specifically, in some embodiments, these completion statuses can be selected to all be at less than 60% completion of the program, and more specifically, in some embodiments, the first completion status can be at 20% completion of the program, the second completion status can be at 30% completion of the program, the third completion status can be at 40% completion of the program, and the fourth completion status can be at 50% completion of the program. Similarly, any desired number of model functions can be associated with any desired number of completion statuses.

In some embodiments, a model function can be selected from the plurality of model functions based on a user's progress through a program. In some embodiments, the user's progress can be compared to one or several status trigger thresholds, each of which status trigger thresholds can be associated with one or more of the model functions. If one of the status triggers is triggered by the user's progress, the corresponding one or several model functions can be selected.

The model functions can comprise a variety of types of models and/or functions. In some embodiments, each of the model functions outputs a function value that can be used in calculating a risk probability. This function value can be calculated by performing one or several mathematical operations on one or several values indicative of one or several user attributes and/or user parameters, also referred to herein as program status parameters. In some embodiments, each of the model functions can use the same program status parameters, and in some embodiments, the model functions can use different program status parameters. In some embodiments, the model functions use different program status parameters when at least one of the model functions uses at least one program status parameter that is not used by others of the model functions.

In some embodiments, a skill model can comprise a statistical model identifying a predictive skill level of one or several users. In some embodiments, this model can identify a single skill level of a user and/or a range of possible skill levels of a user. In some embodiments, this statistical model can identify a skill level of a student-user and an error value or error range associated with that skill level. In some embodiments, the error value can be associated with a confidence interval determined based on a confidence level. Thus, in some embodiments, as the number of user interactions with the content distribution network increases, the confidence level can increase and the error value can decrease such that the range identified by the error value about the predicted skill level is smaller.

In some embodiments, the model database 309, can further include data characterizing one or several attributes of one or several of the model stored in the model database. In some embodiments, this data can characterize aspects of the training of one or several of the model stored in the model database including, for example, identification of one or several sets of training data, identification of attributes of one or several sets of training data, such as, for example, the size of the sets of training data, or the like. In some embodiments, this data can further include data characterizing the confidence of one or several models stored in the model database 309.

A threshold database 310 can store one or several threshold values. These one or several threshold values can delineate between states or conditions. In one exemplary embodiment, for example, a threshold value can delineate between an acceptable user performance and an unacceptable user performance, between content appropriate for a user and content that is inappropriate for a user, between risk levels, or the like.

A prioritization database 311 can include data relating to one or several tasks and the prioritization of those one or several tasks with respect to each other. In some embodiments, the prioritization database 311 can be unique to a specific user, and in some embodiments, the prioritization database 311 can be applicable to a plurality of users. In some embodiments in which the prioritization database 311 is unique to a specific user, the prioritization database 311 can be a sub-database of the user profile database 301. In some embodiments, the prioritization database 311 can include information identifying a plurality of tasks and a relative prioritization amongst that plurality of tasks. In some embodiments, this prioritization can be static and in some embodiments, this prioritization can be dynamic in that the prioritization can change based on updates, for example, one or several of the tasks, the user profile database 301, or the like. In some embodiments, the prioritization database 311 can include information relating to tasks associated with a single course, group, class, or the like, and in some embodiments, the prioritization database 311 can include information relating to tasks associated with a plurality of courses, groups, classes, or the like.

A task can define an objective and/or outcome and can be associated with one or several data packets that can, for example, contribute to user attainment of the objective and/or outcome. In some embodiments, some or all of the data packets contained in the content library database 303 can be linked with one or several tasks stored in the prioritization database 311 such that a single task can be linked and/or associated with one or several data packets.

The prioritization database 311 can further include information relevant to the prioritization of one or several tasks and/or the prioritization database 311 can include information that can be used in determining the prioritization of one or several tasks. In some embodiments, this can include weight data which can identify a relative and/or absolute weight of a task. In some embodiments, for example, the weight data can identify the degree to which a task contributes to an outcome such as, for example, a score or a grade. In some embodiments, this weight data can specify the portion and/or percent of a grade of a class, section, course, or study that results from, and/or that is associated with the task.

The prioritization database 311 can further include information relevant to the composition of the task. In some embodiments, for example, this information, also referred to herein as a composition value, can identify one or several sub-tasks and/or content categories forming the tasks, as well as a contribution of each of those sub-tasks and/or content categories to the task. In some embodiments, the application of the weight data to the composition value can result in the identification of a contribution value for the task and/or for the one or several sub-tasks and/or content categories forming the task. This contribution value can identify the contribution of one, some, or all of the sub-tasks and/or content categories to the outcome such as, for example, the score or the grade.

The calendar data source 312, also referred to herein as the calendar database 312 can include timing information relevant to the tasks contained in the prioritization database 311. In some embodiments, this timing information can identify one or several dates by which the tasks should be completed, one or several event dates associated with the task such as, for example, one or several due dates, test dates, or the like, holiday information, or the like. In some embodiments, the calendar database 312 can further include any information provided to the user relating to other goals, commitments, or the like.

In addition to the illustrative data stores described above, data store server(s) 104 (e.g., database servers, file-based storage servers, etc.) may include one or more external data aggregators 313. External data aggregators 313 may include third-party data sources accessible to the content management network 100, but not maintained by the content management network 100. External data aggregators 313 may include any electronic information source relating to the users, content resources, or applications of the content distribution network 100. For example, external data aggregators 313 may be third-party data stores containing demographic data, education related data, consumer sales data, health related data, and the like. Illustrative external data aggregators 313 may include, for example, social networking web servers, public records data stores, learning management systems, educational institution servers, business servers, consumer sales data stores, medical record data stores, etc. Data retrieved from various external data aggregators 313 may be used to verify and update user account information, suggest user content, and perform user and content evaluations.

With reference now to FIG. 4, a block diagram is shown illustrating an embodiment of one or more content management servers 102 within a content distribution network 100. In such an embodiment, content management server 102 performs internal data gathering and processing of streamed content along with external data gathering and processing. Other embodiments could have either all external or all internal data gathering. This embodiment allows reporting timely information that might be of interest to the reporting party or other parties. In this embodiment, the content management server 102 can monitor gathered information from several sources to allow it to make timely business and/or processing decisions based upon that information. For example, reports of user actions and/or responses, as well as the status and/or results of one or several processing tasks could be gathered and reported to the content management server 102 from a number of sources.

Internally, the content management server 102 gathers information from one or more internal components 402-408. The internal components 402-408 gather and/or process information relating to such things as: content provided to users; content consumed by users; responses provided by users; user skill levels; content difficulty levels; next content for providing to users; etc. The internal components 402-408 can report the gathered and/or generated information in real-time, near real-time or along another time line. To account for any delay in reporting information, a time stamp or staleness indicator can inform others of how timely the information was sampled. The content management server 102 can opt to allow third parties to use internally or externally gathered information that is aggregated within the server 102 by subscription to the content distribution network 100.

A command and control (CC) interface 338 configures the gathered input information to an output of data streams, also referred to herein as content streams. APIs for accepting gathered information and providing data streams are provided to third parties external to the server 102 who want to subscribe to data streams. The server 102 or a third party can design as yet undefined APIs using the CC interface 338. The server 102 can also define authorization and authentication parameters using the CC interface 338 such as authentication, authorization, login, and/or data encryption. CC information is passed to the internal components 402-408 and/or other components of the content distribution network 100 through a channel separate from the gathered information or data stream in this embodiment, but other embodiments could embed CC information in these communication channels. The CC information allows throttling information reporting frequency, specifying formats for information and data streams, deactivation of one or several internal components 402-408 and/or other components of the content distribution network 100, updating authentication and authorization, etc.

The various data streams that are available can be researched and explored through the CC interface 338. Those data stream selections for a particular subscriber, which can be one or several of the internal components 402-408 and/or other components of the content distribution network 100, are stored in the queue subscription information database 322. The server 102 and/or the CC interface 338 then routes selected data streams to processing subscribers that have selected delivery of a given data stream. Additionally, the server 102 also supports historical queries of the various data streams that are stored in an historical data store 334 as gathered by an archive data agent 336. Through the CC interface 338 various data streams can be selected for archiving into the historical data store 334.

Components of the content distribution network 100 outside of the server 102 can also gather information that is reported to the server 102 in real-time, near real-time, or along another time line. There is a defined API between those components and the server 102. Each type of information or variable collected by server 102 falls within a defined API or multiple APIs. In some cases, the CC interface 338 is used to define additional variables to modify an API that might be of use to processing subscribers. The additional variables can be passed to all processing subscribes or just a subset. For example, a component of the content distribution network 100 outside of the server 102 may report a user response, but define an identifier of that user as a private variable that would not be passed to processing subscribers lacking access to that user and/or authorization to receive that user data. Processing subscribers having access to that user and/or authorization to receive that user data would receive the subscriber identifier along with the response reported to that component. Encryption and/or unique addressing of data streams or sub-streams can be used to hide the private variables within the messaging queues.

The user devices 106 and/or supervisor devices 110 communicate with the server 102 through security and/or integration hardware 410. The communication with security and/or integration hardware 410 can be encrypted or not. For example, a socket using a TCP connection could be used. In addition to TCP, other transport layer protocols like Control Transmission Protocol (SCTP) and User Datagram Protocol (UDP) could be used in some embodiments to intake the gathered information. A protocol such as SSL could be used to protect the information over the TCP connection. Authentication and authorization can be performed to any user devices 106 and/or supervisor device interfacing to the server 102. The security and/or integration hardware 410 receives the information from one or several of the user devices 106 and/or the supervisor devices 110 by providing the API and any encryption, authorization, and/or authentication. In some cases, the security and/or integration hardware 410 reformats or rearranges this received information

The messaging bus 412, also referred to herein as a messaging queue or a messaging channel, can receive information from the internal components of the server 102 and/or components of the content distribution network 100 outside of the server 102 and distribute the gathered information as a data stream to any processing subscribers that have requested the data stream from the messaging queue 412. As indicated in FIG. 4, processing subscribers are indicated by a connector to the messaging bus 412, the connector having an arrow head pointing away from the messaging bus 412. In some examples, only data streams within the messaging queue 412 that a particular processing subscriber has subscribed to may be read by that processing subscriber if received at all. Gathered information sent to the messaging queue 412 is processed and returned in a data stream in a fraction of a second by the messaging queue 412. Various multicasting and routing techniques can be used to distribute a data stream from the messaging queue 412 that a number of processing subscribers have requested. Protocols such as Multicast or multiple Unicast could be used to distributed streams within the messaging queue 412. Additionally, transport layer protocols like TCP, SCTP and UDP could be used in various embodiments.

Through the CC interface 338, an external or internal processing subscriber can be assigned one or more data streams within the messaging queue 412. A data stream is a particular type of messages in a particular category. For example, a data stream can comprise all of the data reported to the messaging bus 412 by a designated set of components. One or more processing subscribers could subscribe and receive the data stream to process the information and make a decision and/or feed the output from the processing as gathered information fed back into the messaging queue 412. Through the CC interface 338 a developer can search the available data streams or specify a new data stream and its API. The new data stream might be determined by processing a number of existing data streams with a processing subscriber.

The CDN 110 has internal processing subscribers 402-408 that process assigned data streams to perform functions within the server 102. Internal processing subscribers 402-408 could perform functions such as providing content to a user, receiving a response from a user, determining the correctness of the received response, updating one or several models based on the correctness of the response, recommending new content for providing to one or several users, or the like. The internal processing subscribers 402-408 can decide filtering and weighting of records from the data stream. To the extent that decisions are made based upon analysis of the data stream, each data record is time stamped to reflect when the information was gathered such that additional credibility could be given to more recent results, for example. Other embodiments may filter out records in the data stream that are from an unreliable source or stale. For example, a particular contributor of information may prove to have less than optimal gathered information and that could be weighted very low or removed altogether.

Internal processing subscribers 402-408 may additionally process one or more data streams to provide different information to feed back into the messaging queue 412 to be part of a different data stream. For example, hundreds of user devices 106 could provide responses that are put into a data stream on the messaging queue 412. An internal processing subscriber 402-408 could receive the data stream and process it to determine the difficulty of one or several data packets provided to one or several users and supply this information back onto the messaging queue 412 for possible use by other internal and external processing subscribers.

As mentioned above, the CC interface 338 allows the CDN 110 to query historical messaging queue 412 information. An archive data agent 336 listens to the messaging queue 412 to store data streams in a historical database 334. The historical database 334 may store data streams for varying amounts of time and may not store all data streams. Different data streams may be stored for different amounts of time.

With regards to the components 402-408, the content management server(s) 102 may include various server hardware and software components that manage the content resources within the content distribution network 100 and provide interactive and adaptive content to users on various user devices 106. For example, content management server(s) 102 may provide instructions to and receive information from the other devices within the content distribution network 100, in order to manage and transmit content resources, user data, and server or client applications executing within the network 100.

A content management server 102 may include a packet selection system 402. The packet selection system 402 may be implemented using dedicated hardware within the content distribution network 100 (e.g., a packet selection server 402), or using designated hardware and software resources within a shared content management server 102. In some embodiments, the packet selection system 402 may adjust the selection and adaptive capabilities of content resources to match the needs and desires of the users receiving the content. For example, the packet selection system 402 may query various data stores and servers 104 to retrieve user information, such as user preferences and characteristics (e.g., from a user profile data store 301), user access restrictions to content recourses (e.g., from a content access data store 306), previous user results and content evaluations (e.g., from an evaluation data store 308), and the like. Based on the retrieved information from data stores 104 and other data sources, the packet selection system 402 may modify content resources for individual users.

In some embodiments, the packet selection system 402 can include a recommendation engine, also referred to herein as an adaptive recommendation engine. In some embodiments, the recommendation engine can select one or several pieces of content, also referred to herein as data packets, for providing to a user. These data packets can be selected based on, for example, the information retrieved from the database server 104 including, for example, the user profile database 301, the content library database 303, the model database 309, or the like. In some embodiments, these one or several data packets can be adaptively selected and/or selected according to one or several selection rules. In one embodiment, for example, the recommendation engine can retrieve information from the user profile database 301 identifying, for example, a skill level of the user. The recommendation engine can further retrieve information from the content library database 303 identifying, for example, potential data packets for providing to the user and the difficulty of those data packets and/or the skill level associated with those data packets.

The recommendation engine can identify one or several potential data packets for providing and/or one or several data packets for providing to the user based on, for example, one or several rules, models, predictions, or the like. The recommendation engine can use the skill level of the user to generate a prediction of the likelihood of one or several users providing a desired response to some or all of the potential data packets. In some embodiments, the recommendation engine can pair one or several data packets with selection criteria that may be used to determine which packet should be delivered to a user based on one or several received responses from that student-user. In some embodiments, one or several data packets can be eliminated from the pool of potential data packets if the prediction indicates either too high a likelihood of a desired response or too low a likelihood of a desired response. In some embodiments, the recommendation engine can then apply one or several selection criteria to the remaining potential data packets to select a data packet for providing to the user. These one or several selection criteria can be based on, for example, criteria relating to a desired estimated time for receipt of response to the data packet, one or several content parameters, one or several assignment parameters, or the like.

A content management server 102 also may include a summary model system 404. The summary model system 404 may be implemented using dedicated hardware within the content distribution network 100 (e.g., a summary model server 404), or using designated hardware and software resources within a shared content management server 102. In some embodiments, the summary model system 404 may monitor the progress of users through various types of content resources and groups, such as media compilations, courses, or curriculums in training or educational contexts, interactive gaming environments, and the like. For example, the summary model system 404 may query one or more databases and/or data store servers 104 to retrieve user data such as associated content compilations or programs, content completion status, user goals, results, and the like.

A content management server 102 also may include a response system 406, which can include, in some embodiments, a response processor. The response system 406 may be implemented using dedicated hardware within the content distribution network 100 (e.g., a response server 406), or using designated hardware and software resources within a shared content management server 102. The response system 406 may be configured to receive and analyze information from user devices 106. For example, various ratings of content resources submitted by users may be compiled and analyzed, and then stored in a data store (e.g., a content library data store 303 and/or evaluation data store 308) associated with the content. In some embodiments, the response server 406 may analyze the information to determine the effectiveness or appropriateness of content resources with, for example, a subject matter, an age group, a skill level, or the like. In some embodiments, the response system 406 may provide updates to the packet selection system 402 or the summary model system 404, with the attributes of one or more content resources or groups of resources within the network 100. The response system 406 also may receive and analyze user evaluation data from user devices 106, supervisor devices 110, and administrator servers 116, etc. For instance, response system 406 may receive, aggregate, and analyze user evaluation data for different types of users (e.g., end users, supervisors, administrators, etc.) in different contexts (e.g., media consumer ratings, trainee or student comprehension levels, teacher effectiveness levels, gamer skill levels, etc.).

In some embodiments, the response system 406 can be further configured to receive one or several responses from the user and analyze these one or several responses. In some embodiments, for example, the response system 406 can be configured to translate the one or several responses into one or several observables. As used herein, an observable is a characterization of a received response. In some embodiments, the translation of the one or several response into one or several observables can include determining whether the one or several response are correct responses, also referred to herein as desired responses, or are incorrect responses, also referred to herein as undesired responses. In some embodiments, the translation of the one or several response into one or several observables can include characterizing the degree to which one or several response are desired responses and/or undesired responses. In some embodiments, one or several values can be generated by the response system 406 to reflect user performance in responding to the one or several data packets. In some embodiments, these one or several values can comprise one or several scores for one or several responses and/or data packets.

A content management server 102 also may include a presentation system 408. The presentation system 408 may be implemented using dedicated hardware within the content distribution network 100 (e.g., a presentation server 408), or using designated hardware and software resources within a shared content management server 102. The presentation system 408 can include a presentation engine that can be, for example, a software module running on the content delivery system.

The presentation system 408, also referred to herein as the presentation module or the presentation engine, may receive content resources from the packet selection system 402 and/or from the summary model system 404, and provide the resources to user devices 106. The presentation system 408 may determine the appropriate presentation format for the content resources based on the user characteristics and preferences, and/or the device capabilities of user devices 106. If needed, the presentation system 408 may convert the content resources to the appropriate presentation format and/or compress the content before transmission. In some embodiments, the presentation system 408 may also determine the appropriate transmission media and communication protocols for transmission of the content resources.

In some embodiments, the presentation system 408 may include specialized security and integration hardware 410, along with corresponding software components to implement the appropriate security features content transmission and storage, to provide the supported network and client access models, and to support the performance and scalability requirements of the network 100. The security and integration layer 410 may include some or all of the security and integration components 208 discussed above in FIG. 2, and may control the transmission of content resources and other data, as well as the receipt of requests and content interactions, to and from the user devices 106, supervisor devices 110, administrator servers 116, and other devices in the network 100.

With reference now to FIG. 5, a block diagram of an illustrative computer system is shown. The system 500 may correspond to any of the computing devices or servers of the content distribution network 100 described above, or any other computing devices described herein, and specifically can include, for example, one or several of the user devices 106, the supervisor device 110, and/or any of the servers 102, 104, 108, 112, 114, 116. In this example, computer system 500 includes processing units 504 that communicate with a number of peripheral subsystems via a bus subsystem 502. These peripheral subsystems include, for example, a storage subsystem 510, an I/O subsystem 526, and a communications subsystem 532.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. Such architectures may include, for example, an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which may be implemented as one or more integrated circuits (e.g., a conventional microprocessor or microcontroller), controls the operation of computer system 500. One or more processors, including single core and/or multicore processors, may be included in processing unit 504. As shown in the figure, processing unit 504 may be implemented as one or more independent processing units 506 and/or 508 with single or multicore processors and processor caches included in each processing unit. In other embodiments, processing unit 504 may also be implemented as a quad-core processing unit or larger multicore designs (e.g., hexa-core processors, octo-core processors, ten-core processors, or greater.

Processing unit 504 may execute a variety of software processes embodied in program code, and may maintain multiple concurrently executing programs or processes. At any given time, some or all of the program code to be executed can be resident in processor(s) 504 and/or in storage subsystem 510. In some embodiments, computer system 500 may include one or more specialized processors, such as digital signal processors (DSPs), outboard processors, graphics processors, application-specific processors, and/or the like.

I/O subsystem 526 may include device controllers 528 for one or more user interface input devices and/or user interface output devices 530. User interface input and output devices 530 may be integral with the computer system 500 (e.g., integrated audio/video systems, and/or touchscreen displays), or may be separate peripheral devices which are attachable/detachable from the computer system 500. The I/O subsystem 526 may provide one or several outputs to a user by converting one or several electrical signals to user perceptible and/or interpretable form, and may receive one or several inputs from the user by generating one or several electrical signals based on one or several user-caused interactions with the I/O subsystem such as the depressing of a key or button, the moving of a mouse, the interaction with a touchscreen or trackpad, the interaction of a sound wave with a microphone, or the like.

Input devices 530 may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. Input devices 530 may also include three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additional input devices 530 may include, for example, motion sensing and/or gesture recognition devices that enable users to control and interact with an input device through a natural user interface using gestures and spoken commands, eye gesture recognition devices that detect eye activity from users and transform the eye gestures as input into an input device, voice recognition sensing devices that enable users to interact with voice recognition systems through voice commands, medical imaging input devices, MIDI keyboards, digital musical instruments, and the like.

Output devices 530 may include one or more display subsystems, indicator lights, or non-visual displays such as audio output devices, etc. Display subsystems may include, for example, cathode ray tube (CRT) displays, flat-panel devices, such as those using a liquid crystal display (LCD) or plasma display, light-emitting diode (LED) displays, projection devices, touch screens, and the like. In general, use of the term “output device” is intended to include all possible types of devices and mechanisms for outputting information from computer system 500 to a user or other computer. For example, output devices 530 may include, without limitation, a variety of display devices that visually convey text, graphics, and audio/video information such as monitors, printers, speakers, headphones, automotive navigation systems, plotters, voice output devices, and modems.

Computer system 500 may comprise one or more storage subsystems 510, comprising hardware and software components used for storing data and program instructions, such as system memory 518 and computer-readable storage media 516. The system memory 518 and/or computer-readable storage media 516 may store program instructions that are loadable and executable on processing units 504, as well as data generated during the execution of these programs.

Depending on the configuration and type of computer system 500, system memory 518 may be stored in volatile memory (such as random access memory (RAM) 512) and/or in non-volatile storage drives 514 (such as read-only memory (ROM), flash memory, etc.). The RAM 512 may contain data and/or program modules that are immediately accessible to and/or presently being operated and executed by processing units 504. In some implementations, system memory 518 may include multiple different types of memory, such as static random access memory (SRAM) or dynamic random access memory (DRAM). In some implementations, a basic input/output system (BIOS), containing the basic routines that help to transfer information between elements within computer system 500, such as during start-up, may typically be stored in the non-volatile storage drives 514. By way of example, and not limitation, system memory 518 may include application programs 520, such as client applications, Web browsers, mid-tier applications, server applications, etc., program data 522, and an operating system 524.

Storage subsystem 510 also may provide one or more tangible computer-readable storage media 516 for storing the basic programming and data constructs that provide the functionality of some embodiments. Software (programs, code modules, instructions) that when executed by a processor provide the functionality described herein may be stored in storage subsystem 510. These software modules or instructions may be executed by processing units 504. Storage subsystem 510 may also provide a repository for storing data used in accordance with the present invention.

Storage subsystem 510 may also include a computer-readable storage media reader that can further be connected to computer-readable storage media 516. Together and, optionally, in combination with system memory 518, computer-readable storage media 516 may comprehensively represent remote, local, fixed, and/or removable storage devices plus storage media for temporarily and/or more permanently containing, storing, transmitting, and retrieving computer-readable information.

Computer-readable storage media 516 containing program code, or portions of program code, may include any appropriate media known or used in the art, including storage media and communication media, such as, but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 500.

By way of example, computer-readable storage media 516 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 516 may include, but is not limited to, Zip® drives, flash memory cards, universal serial bus (USB) flash drives, secure digital (SD) cards, DVD disks, digital video tape, and the like. Computer-readable storage media 516 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Communications subsystem 532 may provide a communication interface from computer system 500 and external computing devices via one or more communication networks, including local area networks (LANs), wide area networks (WANs) (e.g., the Internet), and various wireless telecommunications networks. As illustrated in FIG. 5, the communications subsystem 532 may include, for example, one or more network interface controllers (NICs) 534, such as Ethernet cards, Asynchronous Transfer Mode NICs, Token Ring NICs, and the like, as well as one or more wireless communications interfaces 536, such as wireless network interface controllers (WNICs), wireless network adapters, and the like. As illustrated in FIG. 5, the communications subsystem 532 may include, for example, one or more location determining features 538 such as one or several navigation system features and/or receivers, and the like. Additionally and/or alternatively, the communications subsystem 532 may include one or more modems (telephone, satellite, cable, ISDN), synchronous or asynchronous digital subscriber line (DSL) units, FireWire® interfaces, USB® interfaces, and the like. Communications subsystem 536 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

The various physical components of the communications subsystem 532 may be detachable components coupled to the computer system 500 via a computer network, a FireWire® bus, or the like, and/or may be physically integrated onto a motherboard of the computer system 500. Communications subsystem 532 also may be implemented in whole or in part by software.

In some embodiments, communications subsystem 532 may also receive input communication in the form of structured and/or unstructured data feeds, event streams, event updates, and the like, on behalf of one or more users who may use or access computer system 500. For example, communications subsystem 532 may be configured to receive data feeds in real-time from users of social networks and/or other communication services, web feeds such as Rich Site Summary (RSS) feeds, and/or real-time updates from one or more third party information sources (e.g., external data source 313). Additionally, communications subsystem 532 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 532 may output such structured and/or unstructured data feeds, event streams, event updates, and the like to one or more data stores 104 that may be in communication with one or more streaming data source computers coupled to computer system 500.

Due to the ever-changing nature of computers and networks, the description of computer system 500 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

With reference now to FIG. 6, a block diagram illustrating one embodiment of the communication network is shown. Specifically, FIG. 6 depicts one hardware configuration in which messages are exchanged between a source hub 602 and a terminal hub 606 via the communication network 120 that can include one or several intermediate hubs 604. In some embodiments, the source hub 602 can be any one or several components of the content distribution network generating and initiating the sending of a message, and the terminal hub 606 can be any one or several components of the content distribution network 100 receiving and not re-sending the message. In some embodiments, for example, the source hub 602 can be one or several of the user device 106, the supervisor device 110, and/or the server 102, and the terminal hub 606 can likewise be one or several of the user device 106, the supervisor device 110, and/or the server 102. In some embodiments, the intermediate hubs 604 can include any computing device that receives the message and resends the message to a next node.

As seen in FIG. 6, in some embodiments, each of the hubs 602, 604, 606 can be communicatively connected with the data store 104. In such an embodiments, some or all of the hubs 602, 604, 606 can send information to the data store 104 identifying a received message and/or any sent or resent message. This information can, in some embodiments, be used to determine the completeness of any sent and/or received messages and/or to verify the accuracy and completeness of any message received by the terminal hub 606.

In some embodiments, the communication network 120 can be formed by the intermediate hubs 604. In some embodiments, the communication network 120 can comprise a single intermediate hub 604, and in some embodiments, the communication network 120 can comprise a plurality of intermediate hubs. In one embodiment, for example, and as depicted in FIG. 6, the communication network 120 includes a first intermediate hub 604-A and a second intermediate hub 604-B.

With reference now to FIG. 7, a block diagram illustrating one embodiment of user device 106 and supervisor device 110 communication is shown. In some embodiments, for example, a user may have multiple devices that can connect with the content distribution network 100 to send or receive information. In some embodiments, for example, a user may have a personal device such as a mobile device, a smartphone, a tablet, a smartwatch, a laptop, a PC, or the like. In some embodiments, the other device can be any computing device in addition to the personal device. This other device can include, for example, a laptop, a PC, a smartphone, a tablet, a smartwatch, or the like. In some embodiments, the other device differs from the personal device in that the personal device is registered as such within the content distribution network 100 and the other device is not registered as a personal device within the content distribution network 100.

Specifically with respect to FIG. 7 in view of the devices illustrated with FIG. 1, the user device 106 can include a personal user device 106-A and one or several other user devices 106-B. In some embodiments, one or both of the personal user device 106-A and the one or several other user devices 106-B can be communicatively connected to the content management server 102 and/or to the navigation system 122. Similarly, the supervisor device 110 can include a personal supervisor device 110-A and one or several other supervisor devices 110-B. In some embodiments, one or both of the personal supervisor device 110-A and the one or several other supervisor devices 110-B can be communicatively connected to the content management server 102 and/or to the navigation system 122.

In some embodiments, the content distribution network can send one or more alerts to one or more user devices 106 and/or one or more supervisor devices 110 via, for example, the communication network 120. In some embodiments, the receipt of the alert can result in the launching of an application within the receiving device, and in some embodiments, the alert can include a link that, when selected, launches the application or navigates a web-browser of the device of the selector of the link to page or portal associated with the alert.

In some embodiments, for example, the providing of this alert can include the identification of one or several user devices 106 and/or student-user accounts associated with the student-user and/or one or several supervisor devices 110 and/or supervisor-user accounts associated with the supervisor-user. After these one or several devices 106, 110 and/or accounts have been identified, the providing of this alert can include determining an active device of the devices 106, 110 based on determining which of the devices 106, 110 and/or accounts are actively being used, and then providing the alert to that active device.

Specifically, if the user is actively using one of the devices 106, 110 such as the other user device 106-B and the other supervisor device 110-B, and/or accounts, the alert can be provided to the user via that other device 106-B, 110-B, and/or account that is actively being used. If the user is not actively using another device 106-B, 110-B, and/or account, a personal device 106-A, 110-A device, such as a smart phone or tablet, can be identified and the alert can be provided to this personal device 106-A, 110-A. In some embodiments, the alert can include code to direct the default device to provide an indicator of the received alert such as, for example, an oral, tactile, or visual indicator of receipt of the alert.

In some embodiments, the recipient device 106, 110 of the alert can provide an indication of receipt of the alert. In some embodiments, the presentation of the alert can include the control of the I/O subsystem 526 to, for example, provide an oral, tactile, and/or visual indicator of the alert and/or of the receipt of the alert. In some embodiments, this can include controlling a screen of the supervisor device 110 to display the alert, data contained in alert and/or an indicator of the alert.

With reference now to FIG. 8, a schematic illustration of one embodiment of an application stack, and particularly of a stack 650 is shown. In some embodiments, the content distribution network 100 can comprise a portion of the stack 650 that can include an infrastructure layer 652, a platform layer 654, an applications layer 656, and a products layer 658. In some embodiments, the stack 650 can comprise some or all of the layers, hardware, and/or software to provide one or several desired functionalities and/or productions.

As depicted in FIG. 8, the infrastructure layer 652 can include one or several servers, communication networks, data stores, privacy servers, and the like. In some embodiments, the infrastructure layer can further include one or several user devices 106 and/or supervisor devices 110 connected as part of the content distribution network.

The platform layer can include one or several platform software programs, modules, and/or capabilities. These can include, for example, identification services, security services, and/or adaptive platform services 660. In some embodiments, the identification services can, for example, identify one or several users, components of the content distribution network 100, or the like. The security services can monitor the content distribution network for one or several security threats, breaches, viruses, malware, or the like. The adaptive platform services 660 can receive information from one or several components of the content distribution network 100 and can provide predictions, models, recommendations, or the like based on that received information. The functionality of the adaptive platform services 660 will be discussed in greater detail in FIGS. 9-11, below.

The applications layer 656 can include software or software modules upon or in which one or several product softwares or product software modules can operate. In some embodiments, the applications layer 656 can include, for example, a management system, record system, or the like. In some embodiments, the management system can include, for example, a Learning Management System (LMS), a Content Management System (CMS), or the like. The management system can be configured to control the delivery of one or several resources to a user and/or to receive one or several responses from the user. In some embodiments, the records system can include, for example, a virtual gradebook, a virtual counselor, or the like.

The products layer can include one or several software products and/or software module products. These software products and/or software module products can provide one or several services and/or functionalities to one or several users of the software products and/or software module products.

With reference now to FIG. 9-11, schematic illustrations of embodiments of communication and processing flow of modules within the content distribution network 100 are shown. In some embodiments, the communication and processing can be performed in portions of the platform layer 654 and/or applications layer 656. FIG. 9 depicts a first embodiment of such communications or processing that can be in the platform layer 654 and/or applications layer 656 via the message channel 412.

The platform layer 654 and/or applications layer 656 can include a plurality of modules that can be embodied in software or hardware. In some embodiments, some or all of the modules can be embodied in hardware and/or software at a single location, and in some embodiments, some or all of these modules can be embodied in hardware and/or software at multiple locations. These modules can perform one or several processes including, for example, a presentation process 670, a response process 676, a summary model process 680, and a packet selection process 684.

The presentation process 670 can, in some embodiments, include one or several method and/or steps to deliver content to one or several user devices 106 and/or supervisor devices 110. The presentation process 670 can be performed by a presenter module 672 and a view module 674. The presenter module 672 can be a hardware or software module of the content distribution network 100, and specifically of the server 102. In some embodiments, the presenter module 672 can include one or several portions, features, and/or functionalities that are located on the server 102 and/or one or several portions, features, and/or functionalities that are located on the user device 106. In some embodiments, the presenter module 672 can be embodied in the presentation system 408.

The presenter module 672 can control the providing of content to one or several user devices 106 and/or supervisor devices 110. Specifically, the presenter module 672 can control the generation of one or several messages to provide content to one or several desired user devices 106 and/or supervisor devices 110. The presenter module 672 can further control the providing of these one or several messages to the desired one or several desired user devices 106 and/or supervisor devices 110. Thus, in some embodiments, the presenter module 672 can control one or several features of the communications subsystem 532 to generate and send one or several electrical signals comprising content to one or several user devices 106 and/or supervisor devices 110.

In some embodiments, the presenter module 672 can control and/or manage a portion of the presentation functions of the presentation process 670, and can specifically manage an “outer loop” of presentation functions. As used herein, the outer loop refers to tasks relating to the tracking of a user's progress through all or a portion of a group of data packets. In some embodiments, this can include the identification of one or several completed data packets or nodes and/or the non-adaptive selection of one or several next data packets or nodes according to, for example, one or several fixed rules. Such non-adaptive selection does not rely on the use of predictive models, but rather on rules identifying next data packets based on data relating to the completion of one or several previously completed data packets or assessments and/or whether one or several previously completed data packets were successfully completed.

In some embodiments, and due to the management of the outer loop of presentation functions including the non-adaptive selection of one or several next data packets, nodes, or tasks by the presenter module, the presenter module can function as a recommendation engine referred to herein as a first recommendation engine or a rules-based recommendation engine. In some embodiments, the first recommendation engine can be configured to select a next node for a user based on one or all of: the user's current location in the content network; potential next nodes; the user's history including the user's previous responses; and one or several guard conditions associated with the potential next nodes. In some embodiments, a guard condition defines one or several prerequisites for entry into, or exit from, a node.

In some embodiments, the presenter module 672 can include a portion located on the server 102 and/or a portion located on the user device 106. In some embodiments, the portion of the presenter module 672 located on the server 102 can receive data packet information and provide a subset of the received data packet information to the portion of the presenter module 672 located on the user device 106. In some embodiments, this segregation of functions and/or capabilities can prevent solution data from being located on the user device 106 and from being potentially accessible by the user of the user device 106.

In some embodiments, the portion of the presenter module 672 located on the user device 106 can be further configured to receive the subset of the data packet information from the portion of the presenter module 672 located on the server 102 and provide that subset of the data packet information to the view module 674. In some embodiments, the portion of the presenter module 672 located on the user device 106 can be further configured to receive a content request from the view module 674 and to provide that content request to the portion of the presenter module 674 located on the server 102.

The view module 674 can be a hardware or software module of some or all of the user devices 106 and/or supervisor devices 110 of the content distribution network 100. The view module 674 can receive one or several electrical signals and/or communications from the presenter module 672 and can provide the content received in those one or several electrical signals and/or communications to the user of the user device 106 and/or supervisor device 110 via, for example, the I/O subsystem 526.

In some embodiments, the view module 674 can control and/or monitor an “inner loop” of presentation functions. As used herein, the inner loop refers to tasks relating to the tracking and/or management of a user's progress through a data packet. This can specifically relate to the tracking and/or management of a user's progression through one or several pieces of content, questions, assessments, and/or the like of a data packet. In some embodiments, this can further include the selection of one or several next pieces of content, next questions, next assessments, and/or the like of the data packet for presentation and/or providing to the user of the user device 106.

In some embodiments, one or both of the presenter module 672 and the view module 674 can comprise one or several presentation engines. In some embodiments, these one or several presentation engines can comprise different capabilities and/or functions. In some embodiments, one of the presentation engines can be configured to track the progress of a user through a single data packet, task, content item, or the like, and in some embodiments, one of the presentation engines can track the progress of a user through a series of data packets, tasks, content items, or the like.

The response process 676 can comprise one or several methods and/or steps to evaluate a response. In some embodiments, this can include, for example, determining whether the response comprises a desired response and/or an undesired response. In some embodiments, the response process 676 can include one or several methods and/or steps to determine the correctness and/or incorrectness of one or several received responses. In some embodiments, this can include, for example, determining the correctness and/or incorrectness of a multiple choice response, a true/false response, a short answer response, an essay response, or the like. In some embodiments, the response processor can employ, for example, natural language processing, semantic analysis, or the like in determining the correctness or incorrectness of the received responses.

In some embodiments, the response process 676 can be performed by a response processor 678, also referred to herein as a math engine 678. The response processor 678 can be a hardware or software module of the content distribution network 100, and specifically of the server 102. In some embodiments, the response processor 678 can be embodied in the response system 406. In some embodiments, the response processor 678 can be communicatively connected to one or more of the modules of the presentation process 670 such as, for example, the presenter module 672 and/or the view module 674. In some embodiments, the response processor 678 can be communicatively connected with, for example, the message channel 412 and/or other components and/or modules of the content distribution network 100.

The summary model process 680 can comprise one or several methods and/or steps to generate and/or update one or several models. In some embodiments, this can include, for example, implementing information received either directly or indirectly from the response processor 678 to update one or several models. In some embodiments, the summary model process 680 can include the update of a model relating to one or several user attributes such as, for example, a user skill model, a user knowledge model, a learning style model, or the like. In some embodiments, the summary model process 680 can include the update of a model relating to one or several content attributes including attributes relating to a single content item and/or data packet and/or attributes relating to a plurality of content items and/or data packets. In some embodiments, these models can relate to an attribute of the one or several data packets such as, for example, difficulty, discrimination, required time, or the like.

In some embodiments, the summary model process 680 can be performed by the model engine 682. In some embodiments, the model engine 682 can be a hardware or software module of the content distribution network 100, and specifically of the server 102. In some embodiments, the model engine 682 can be embodied in the summary model system 404.

In some embodiments, the model engine 682 can be communicatively connected to one or more of the modules of the presentation process 760 such as, for example, the presenter module 672 and/or the view module 674, can be connected to the response processor 678 and/or the recommendation. In some embodiments, the model engine 682 can be communicatively connected to the message channel 412 and/or other components and/or modules of the content distribution network 100.

The packet selection process 684 can comprise one or several steps and/or methods to identify and/or select a data packet for presentation to a user. In some embodiments, this data packet can comprise a plurality of data packets. In some embodiments, this data packet can be selected according to one or several models updated as part of the summary model process 680. In some embodiments, this data packet can be selected according to one or several rules, probabilities, models, or the like. In some embodiments, the one or several data packets can be selected by the combination of a plurality of models updated in the summary model process 680 by the model engine 682. In some embodiments, these one or several data packets can be selected by a recommendation engine 686. The recommendation engine 686 can be a hardware or software module of the content distribution network 100, and specifically of the server 102. In some embodiments, the recommendation engine 686 can be embodied in the packet selection system 402. In some embodiments, the recommendation engine 686 can be communicatively connected to one or more of the modules of the presentation process 670, the response process 676, and/or the summary model process 680 either directly and/or indirectly via, for example, the message channel.

In some embodiments, and as depicted in FIG. 9, a presenter module 672 can receive a data packet for presentation to a user device 106. This data packet can be received, either directly or indirectly, from a recommendation engine 686. In some embodiments, for example, the presenter module 672 can receive a data packet for providing to a user device 106 from the recommendation engine 686, and in some embodiments, the presenter module 672 can receive an identifier of a data packet for providing to a user device 106 via a view module 674. This can be received from the recommendation engine 686 via a message channel 412. Specifically, in some embodiments, the recommendation engine 686 can provide data to the message channel 412 indicating the identification and/or selection of a data packet for providing to a user via a user device 106. In some embodiments, this data indicating the identification and/or selection of the data packet can identify the data packet and/or can identify the intended recipient of the data packet.

The message channel 412 can output this received data in the form of a data stream 690 which can be received by, for example, the presenter module 672, the model engine 682, and/or the recommendation engine 686. In some embodiments, some or all of: the presenter module 672, the model engine 682, and/or the recommendation engine 686 can be configured to parse and/or filter the data stream 690 to identify data and/or events relevant to their operation. Thus, for example, the presenter module 672 can be configured to parse the data stream for information and/or events relevant to the operation of the presenter module 672.

In some embodiments, the presenter module 672 can, extract the data packet from the data stream 690 and/or extract data identifying the data packet and/or indicating the selecting of a data packet from the data stream. In the event that data identifying the data packet is extracted from the data stream 690, the presenter module 672 can request and receive the data packet from the database server 104, and specifically from the content library database 303. In embodiments in which data indicating the selection of a data packet is extracted from the data stream 690, the presenter module 672 can request and receive identification of the data packet from the recommendation engine 686 and then request and receive the data packet from the database server 104, and specifically from the content library database 303, and in some embodiments in which data indicating the selection of a data packet is extracted from the data stream 690, the presenter module 672 can request and receive the data packet from the recommendation engine 686.

The presenter module can then, provide the data packet and/or portions of the data packet to the view module 674. In some embodiments, for example, the presenter module 672 can retrieve one or several rules and/or conditions that can be, for example, associated with the data packet and/or stored in the database server 104. In some embodiments, these rules and/or conditions can identify portions of a data packet for providing to the view module 674 and/or portions of a data packet to not provide to the view module 674. In some embodiments, for example, sensitive portions of a data packet, such as, for example, solution information to any questions associated with a data packet, is not provided to the view module 674 to prevent the possibility of undesired access to those sensitive portions of the data packet. Thus, in some embodiments, the one or several rules and/or conditions can identify portions of the data packet for providing to the view module 674 and/or portions of the data packet for not providing to the view module.

In some embodiments, the presenter module 672 can, according to the one or more rules and/or conditions, generate and transmit an electronic message containing all or portions of the data packet to the view module 674. The view module 674 can receive these all or portions of the data packet and can provide all or portions of this information to the user of the user device 106 associated with the view module 674 via, for example, the I/O subsystem 526. In some embodiments, as part of the providing of all or portions of the data packet to the user of the view module 674, one or several user responses can be received by the view module 674. In some embodiments, these one or several user responses can be received via the I/O subsystem 526 of the user device 106.

After one or several user responses have been received, the view module 674 can provide the one or several user responses to the response processor 678. In some embodiments, these one or several responses can be directly provided to the response processor 678, and in some embodiments, these one or several responses can be provided indirectly to the response processor 678 via the message channel 412.

After the response processor 678 receives the one or several responses, the response processor 678 can determine whether the responses are desired responses and/or the degree to which the received responses are desired responses. In some embodiments, the response processor can make this determination via, for example, use of one or several techniques, including, for example, natural language processing (NLP), semantic analysis, or the like.

In some embodiments, the response processor can determine whether a response is a desired response and/or the degree to which a response is a desired response with comparative data which can be associated with the data packet. In some embodiments, this comparative data can comprise, for example, an indication of a desired response and/or an indication of one or several undesired responses, a response key, a response rubric comprising one or several criterion for determining the degree to which a response is a desired response, or the like. In some embodiments, the comparative data can be received as a portion of and/or associated with a data packet. In some embodiments, the comparative data can be received by the response processor 678 from the presenter module 672 and/or from the message channel 412. In some embodiments, the response data received from the view module 674 can comprise data identifying the user and/or the data packet or portion of the data packet with which the response is associated. In some embodiments in which the response processor 678 merely receives data identifying the data packet and/or portion of the data packet associated with the one or several responses, the response processor 678 can request and/or receive comparative data from the database server 104, and specifically from the content library database 303 of the database server 104.

After the comparative data has been received, the response processor 678 determines whether the one or several responses comprise desired responses and/or the degree to which the one or several responses comprise desired responses. The response processor can then provide the data characterizing whether the one or several responses comprises desired responses and/or the degree to which the one or several responses comprise desired responses to the message channel 412. The message channel can, as discussed above, include the output of the response processor 678 in the data stream 690 which can be constantly output by the message channel 412.

In some embodiments, the model engine 682 can subscribe to the data stream 690 of the message channel 412 and can thus receive the data stream 690 of the message channel 412 as indicated in FIG. 9. The model engine 682 can monitor the data stream 690 to identify data and/or events relevant to the operation of the model engine. In some embodiments, the model engine 682 can monitor the data stream 690 to identify data and/or events relevant to the determination of whether a response is a desired response and/or the degree to which a response is a desired response.

When a relevant event and/or relevant data is identified by the model engine, the model engine 682 can take the identified relevant event and/or relevant data and modify one or several models. In some embodiments, this can include updating and/or modifying one or several models relevant to the user who provided the responses, updating and/or modifying one or several models relevant to the data packet associated with the responses, and/or the like. In some embodiments, these models can be retrieved from the database server 104, and in some embodiments, can be retrieved from the model data source 309 of the database server 104.

After the models have been updated, the updated models can be stored in the database server 104. In some embodiments, the model engine 682 can send data indicative of the event of the completion of the model update to the message channel 412. The message channel 412 can incorporate this information into the data stream 690 which can be received by the recommendation engine 686. The recommendation engine 686 can monitor the data stream 690 to identify data and/or events relevant to the operation of the recommendation engine 686. In some embodiments, the recommendation engine 686 can monitor the data stream 690 to identify data and/or events relevant to the updating of one or several models by the model engine 682.

When the recommendation engine 686 identifies information in the data stream 690 indicating the completion of the summary model process 680 for models relevant to the user providing the response and/or for models relevant to the data packet provided to the user, the recommendation engine 686 can identify and/or select a next data packet for providing to the user and/or to the presentation process 470. In some embodiments, this selection of the next data packet can be performed according to one or several rules and/or conditions. After the next data packet has been selected, the recommendation engine 686 can provide information to the model engine 682 identifying the next selected data packet and/or to the message channel 412 indicating the event of the selection of the next content item. After the message channel 412 receives information identifying the selection of the next content item and/or receives the next content item, the message channel 412 can include this information in the data stream 690 and the process discussed with respect to FIG. 9 can be repeated.

With reference now to FIG. 10, a schematic illustration of a second embodiment of communication or processing that can be in the platform layer 654 and/or applications layer 656 via the message channel 412 is shown. In the embodiment depicted in FIG. 10, the data packet provided to the presenter module 672 and then to the view module 674 does not include a prompt for a user response and/or does not result in the receipt of a user response. As no response is received, when the data packet is completed, nothing is provided to the response processor 678, but rather data indicating the completion of the data packet is provided from one of the view module 674 and/or the presenter module 672 to the message channel 412. The data is then included in the data stream 690 and is received by the model engine 682 which uses the data to update one or several models. After the model engine 682 has updated the one or several models, the model engine 682 provides data indicating the completion of the model updates to the message channel 412. The message channel 412 then includes the data indicating the completion of the model updates in the data stream 690 and the recommendation engine 686, which can subscribe to the data stream 690, can extract the data indicating the completion of the model updates from the data stream 690. The recommendation engine 686 can then identify a next one or several data packets for providing to the presenter module 672, and the recommendation engine 686 can then, either directly or indirectly, provide the next one or several data packets to the presenter module 672.

With reference now to FIG. 11, a schematic illustration of an embodiment of dual communication, or hybrid communication, in the platform layer 654 and/or applications layer 656 is shown. Specifically, in this embodiment, some communication is synchronous with the completion of one or several tasks and some communication is asynchronous. Thus, in the embodiment depicted in FIG. 11, the presenter module 672 communicates synchronously with the model engine 682 via a direct communication 692 and communicates asynchronously with the model engine 682 via the message channel 412.

Specifically, and with reference to FIG. 11, the presenter module 672 can receive and/or select a data packet for presentation to the user device 106 via the view module 674. In some embodiments, the presenter module 672 can identify all or portions of the data packet that can be provided to the view module 674 and portions of the data packet for retaining form the view module 674. In some embodiments, the presenter module can provide all or portions of the data packet to the view module 674. In some embodiments, and in response to the receipt of all or portions of the data packet, the view module 674 can provide a confirmation of receipt of the all or portions of the data packet and can provide those all or portions of the data packet to the user via the user device 106. In some embodiments, the view module 674 can provide those all or portions of the data packet to the user device 106 while controlling the inner loop of the presentation of the data packet to the user via the user device 106.

After those all or portions of the data packet have been provided to the user device 106, a response indicative of the completion of one or several tasks associated with the data packet can be received by the view module 674 from the user device 106, and specifically from the I/O subsystem 526 of the user device 106. In response to this receive, the view module 674 can provide an indication of this completion status to the presenter module 672 and/or can provide the response to the response processor 678.

After the response has been received by the response processor 678, the response processor 678 can determine whether the received response is a desired response. In some embodiments, this can include, for example, determining whether the response comprises a correct answer and/or the degree to which the response comprises a correct answer.

After the response processor has determined whether the received response is a desired response, the response processor 678 can provide an indicator of the result of the determination of whether the received response is a desired response to the presenter module 672. In response to the receipt of the indicator of whether the result of the determination of whether the received response is a desired response, the presenter module 672 can synchronously communicate with the model engine 682 via a direct communication 692 and can asynchronously communicate with model engine 682 via the message channel 412. In some embodiments, the synchronous communication can advantageously include two-way communication between the model engine 682 and the presenter module 672 such that the model engine 682 can provide an indication to the presenter module 672 when model updating is completed by the model engine.

After the model engine 682 has received one or both of the synchronous and asynchronous communications, the model engine 682 can update one or several models relating to, for example, the user, the data packet, or the like. After the model engine 682 has completed the updating of the one or several models, the model engine 682 can send a communication to the presenter module 672 indicating the completion of the updated one or several modules.

After the presenter module 672 receives the communication indicating the completion of the updating of the one or several models, the presenter module 672 can send a communication to the recommendation engine 686 requesting identification of a next data packet. As discussed above, the recommendation engine 686 can then retrieve the updated model and retrieve the user information. With the updated models and the user information, the recommendation engine can identify a next data packet for providing to the user, and can provide the data packet to the presenter module 672. In some embodiments, the recommendation engine 686 can further provide an indication of the next data packet to the model engine 682, which can use this information relating to the next data packet to update one or several models, either immediately, or after receiving a communication from the presenter module 672 subsequent to the determination of whether a received response for that data packet is a desired response.

With reference now to FIG. 12, a schematic illustration of one embodiment of the presentation process 670 is shown. Specifically, FIG. 12 depicts multiple portions of the presenter module 672, namely, the external portion 673 and the internal portion 675. In some embodiments, the external portion 673 of the presenter module 672 can be located in the server, and in some embodiments, the internal portion 675 of the presenter module 672 can be located in the user device 106. In some embodiments, the external portion 673 of the presenter module can be configured to communicate and/or exchange data with the internal portion 675 of the presenter module 672 as discussed herein. In some embodiments, for example, the external portion 673 of the presenter module 672 can receive a data packet and can parse the data packet into portions for providing to the internal portion 675 of the presenter module 672 and portions for not providing to the internal portion 675 of the presenter module 672. In some embodiments, the external portion 673 of the presenter module 672 can receive a request for additional data and/or an additional data packet from the internal portion 675 of the presenter module 672. In such an embodiment, the external portion 673 of the presenter module 672 can identify and retrieve the requested data and/or the additional data packet from, for example, the database server 104 and more specifically from the content library database 104.

With reference now to FIG. 13, a flowchart illustrating one embodiment of a process 440 for data management is shown. In some embodiments, the process 440 can be performed by the content management server 102, and more specifically by the presentation system 408 and/or by the presentation module or presentation engine. In some embodiments, the process 440 can be performed as part of the presentation process 670.

The process 440 begins at block 442, wherein a data packet is identified. In some embodiments, the data packet can be a data packet for providing to a student-user. In some embodiments, the data packet can be identified based on a communication received either directly or indirectly from the recommendation engine 686.

After the data packet has been identified, the process 440 proceeds to block 444, wherein the data packet is requested. In some embodiments, this can include the requesting of information relating to the data packet such as the data forming the data packet. In some embodiments, this information can be requested from, for example, the content library database 303. After the data packet has been requested, the process 440 proceeds to block 446, wherein the data packet is received. In some embodiments, the data packet can be received by the presentation system 408 from, for example, the content library database 303.

After the data packet has been received, the process 440 proceeds to block 448, wherein one or several data components are identified. In some embodiments, for example, the data packet can include one or several data components which can, for example, contain different data. In some embodiments, one of these data components, referred to herein as a presentation component, can include content for providing to the user, which content can include one or several requests and/or questions and/or the like. In some embodiments, one of these data components, referred to herein as a response component, can include data used in evaluating one or several responses received from the user device 106 in response to the data packet, and specifically in response to the presentation component and/or the one or several requests and/or questions of the presentation component. Thus, in some embodiments, the response component of the data packet can be used to ascertain whether the user has provided a desired response or an undesired response.

After the data components have been identified, the process 440 proceeds to block 450, wherein a delivery data packet is identified. In some embodiments, the delivery data packet can include the one or several data components of the data packets for delivery to a user such as the user via the user device 106. In some embodiments, the delivery packet can include the presentation component, and in some embodiments, the delivery packet can exclude the response packet. After the delivery data packet has been generated, the process 440 proceeds to block 452, wherein the delivery data packet is provided to the user device 106 and more specifically to the view module 674. In some embodiments, this can include providing the delivery data packet to the user device 106 via, for example, the communication network 120.

After the delivery data packet has been provided to the user device 106, the process 440 proceeds to block 454, wherein the data packet and/or one or several components thereof is sent to and/or provided to the response processor 678. In some embodiments, this sending of the data packet and/or one or several components thereof to the response processor can include receiving a response from the user, and sending the response to the user to the response processor simultaneous with the sending of the data packet and/or one or several components thereof to the response processor. In some embodiments, for example, this can include providing the response component to the response processor. In some embodiments, the response component can be provided to the response processor from the presentation system 408.

With reference now to FIG. 14, a flowchart illustrating one embodiment of a process 460 for evaluating a response is shown. In some embodiments, the process can be performed as a part of the response process 676 and can be performed by, for example, the response system 406 and/or by the response processor 678. In some embodiments, the process 460 can be performed by the response system 406 in response to the receipt of a response, either directly or indirectly, from the user device 106 or from the view module 674.

The process 460 begins at block 462, wherein a response is received from, for example, the user device 106 via, for example, the communication network 120. After the response has been received, the process 460 proceeds to block 464, wherein the data packet associated with the response is received. In some embodiments, this can include receiving all or one or several components of the data packet such as, for example, the response component of the data packet. In some embodiments, the data packet can be received by the response processor from the presentation engine.

After the data packet has been received, the process 460 proceeds to block 466, wherein the response type is identified. In some embodiments, this identification can be performed based on data, such as metadata associated with the response. In other embodiments, this identification can be performed based on data packet information such as the response component.

In some embodiments, the response type can identify one or several attributes of the one or several requests and/or questions of the data packet such as, for example, the request and/or question type. In some embodiments, this can include identifying some or all of the one or several requests and/or questions as true/false, multiple choice, short answer, essay, or the like.

After the response type has been identified, the process 460 proceeds to block 468, wherein the data packet and the response are compared to determine whether the response comprises a desired response and/or an undesired response. In some embodiments, this can include comparing the received response and the data packet to determine if the received response matches all or portions of the response component of the data packet, to determine the degree to which the received response matches all or portions of the response component, to determine the degree to which the received response embodies one or several qualities identified in the response component of the data packet, or the like. In some embodiments, this can include classifying the response according to one or several rules. In some embodiments, these rules can be used to classify the response as either desired or undesired. In some embodiments, these rules can be used to identify one or several errors and/or misconceptions evidenced in the response. In some embodiments, this can include, for example: use of natural language processing software and/or algorithms; use of one or several digital thesauruses; use of lemmatization software, dictionaries, and/or algorithms; or the like.

After the data packet and the response have been compared, the process 460 proceeds to block 470 wherein response desirability is determined. In some embodiments this can include, based on the result of the comparison of the data packet and the response, whether the response is a desired response or is an undesired response. In some embodiments, this can further include quantifying the degree to which the response is a desired response. This determination can include, for example, determining if the response is a correct response, an incorrect response, a partially correct response, or the like. In some embodiments, the determination of response desirability can include the generation of a value characterizing the response desirability and the storing of this value in one of the databases 104 such as, for example, the user profile database 301. After the response desirability has been determined, the process 460 proceeds to block 472, wherein an assessment value is generated. In some embodiments, the assessment value can be an aggregate value characterizing response desirability for one or more of a plurality of responses. This assessment value can be stored in one of the databases 104 such as the user profile database 301.

In some embodiments, content provisioning performed in accordance with the processes of FIGS. 11 through 14 can provide significant benefits over current content provisioning with a computer, especially over current content provisioning with a computer in an educational environment. In some embodiments, content provisioning as described in FIGS. 11 through 14 can be based on real-time and dynamic prioritization that can be based on models of one or several user attributes such as user skill level, models of one or several task attributes, such as task difficulty levels, or the like. This provides the significant benefit of accurately selecting content most suited for delivery which increases the efficiency with which content is provided to the user.

Embodiments of the present disclosure relate to systems and methods for improving content creation, content curation, input receipt, and adaptivity. Historically, education has been accomplished via direct or indirect interactions between students and one or several teachers. While this educational model can be successful, problems arise when the number of students increases with respect to the number of teachers, when students struggle to master content, and/or when a teacher must select content for providing to one or several students.

The integration of computers into the educational space has promised to solve these problems and improve learning and educational outcomes. However, the reality has fallen short of the hoped improvements. For example, while a recommendation engine may be able to select and recommend content for providing to a student legacy content that predates, in many instances, the current digital educational space is unavailable for presentation and is unknown to recommendation engines. Further, because of the volume of this legacy content, the bringing of this legacy content into advance educational systems is prohibitively expensive.

In other instances, what content may be provided to a student, receipt of responses from the student is limited in many ways. For example, while a student may interact with the user interface to input one or several numbers, letters, characters, such interfaces do not easily lend themselves for lengthy solution activity as may be required for evaluation of a math problem, or a math-based related problem. Further, while scoring engines may be able to evaluate a response to a problem, scoring engines have been unable to or have struggled in evaluating steps to solving a problem. Accordingly, improvements to recommendation engines, content curation engines, scoring engines, and/or other components or modules of a learning system are desired.

The present disclosure includes solutions to these problems. For instance, the present disclosure relates to systems and methods for content curation and/or content creation. These systems and methods can be used to bring legacy content into the digital world by, for example, identifying traits or attributes of the legacy content, grouping portions of the legacy content, identifying learning objectives of the legacy content, or the like. Some embodiments of the present disclosure further relate to the training of one or several models for content creation and/or content curation. These embodiments, can include systems and methods whereby training of a machine learning model can be automated to thereby allow closed-loop unsupervised training. Additionally, some embodiments of the present disclosure relate to systems and/or methods of content creation, according to one or several received inputs and/or systems and/or methods of content customization according to attributes extracted from one or several user profiles.

The present disclosure relates to systems and methods for receiving user input at an educational system, such as the content distribution network 100. These systems enable, for example, identification of one or several steps taken to solve a problem can be presented to the user in the form of a content item. In some embodiments, the end point can be received via, for example, handwriting on a touchscreen, equation editor, OCR, voice, eye movement, handwriting, brainwave interpretation, brain coupling, scanning, a biological response, and/or photo. In some embodiments, this can include parsing of a received digital response to identify one or several steps in solving a problem.

The present disclosure relates to scoring, adaptivity, and/or content recommendation. This can include the identification of one or several steps in response, the evaluation of these one or several steps in response, providing remediation based on the evaluation of these one or several steps, and/or providing next content based on the evaluation of these one or several steps. This can further include the generation of one or several profiles tracking and/or predicting a user's movement through a learning graph, such as a domain graph.

With reference now to FIG. 15, a flowchart illustrating one embodiment of a process 700 for hybrid solution evaluation is shown. The process 700 can be performed by all or portions of the system 100 including by the server 102, also referred to herein as the processor 102. The process 700 begins at block 702 wherein the readable response is received. In some embodiments, the readable response can comprise a computer readable character string. In some embodiments, this computer readable character string can be generated using an OCR technique such as, for example, the OCR techniques described herein. In some embodiments, the computer readable character string can be received by the server 102. In some embodiments, the computer readable character string can be received by the server 102 from the database server 104 and/or from another component of the system 100.

At block 704 metadata associated with the received readable response is received. In some embodiments, this can be metadata of the problem being answered by the readable response. In some embodiments, there may be minimal metadata associated with the received readable response, and in some embodiments there may be no metadata associated with the received readable response. The metadata may be received by the server 102 from the database server 104, and specifically from the content library database 303 of the database server 104.

At block 706 expression trees are generated for the readable response. In some embodiments, two expression trees are generated for each step in the readable response. The generation of the expression trees can include the parsing of the readable response into steps and/or the identification of steps within the readable response. A step can be selected and expression trees can be generated for that step. This process can be repeated until expression trees have been generated for each step in the readable response.

In such embodiments, the expression trees for each step in the readable response can include a first expression tree characterizing variables and operations in the step, and a second expression tree characterizing rules applicable to the step to solve the step. In some embodiments, the first expression tree of a step can be created by ingesting the step into the math engine and specifically into the computer algebra system. The computer algebra system can output the first expression tree, also referred to herein as a “first type of expression tree”. Nodes associated with operations in the first expression tree can be identified and tokenized. The second expression tree, also referred to herein as a “second type of expression tree,” can be created by the replacement of nodes indicative of operations in the first expression tree with tokens, and, in some embodiments, the second expression tree can be stored in an adjacency matrix. The expression trees can be generated by the server 102 and specifically by the math engine of the server 102. As used herein, “expression tree” can refer to a single expression tree, or can refer to a pair of expression trees including a first type of expression tree and a second type of expression tree.

At block 708 the earliest unevaluated step in the readable response is selected. In some embodiments, for example, the readable response can comprise a plurality of steps, which plurality of steps can include a first step, one or several intermediate steps, and the last step. In some embodiments, the first step is the first line of characters in the readable response. In embodiments in which the problem associated with the readable response is unknown, this first line and/or the first step is assumed to be correct and is thus an evaluated step. In such an embodiment in which the first step is assumed to be correct, the earliest unevaluated step can be the second step or any other step of the intermediate steps, or the final step. In some embodiments, when a step is evaluated, an indicator of the completion of the evaluation is added to the step and/or to data associated with the step. In such an embodiment, the earliest unevaluated step is a step that is not associated with an indication of the completion of a valuation of that step. The earliest unevaluated step can be selected by the server 102.

After the earliest unevaluated step is identified, the process 700 proceeds to decision state 710 wherein it is determined if the earliest unevaluated step is the last step. If the earliest unevaluated step is the last step then the process 700 proceeds to decision state 712 where it is determined if the earliest unevaluated step is correct. In some embodiments, this can include applying the math engine to the earliest unevaluated step, and specifically the computer algebra system. The math engine, and specifically the computer algebra system can determine the equivalency of the earliest unevaluated step to one or several previous or preceding steps. In some embodiments, the math engine can determine the equivalency of the earliest unevaluated step to a step preceding the earliest unevaluated step. In some embodiments, this preceding step is the first step in the response, and in some embodiments, this preceding step is any preceding step determined to be correct. If it is determined that the earliest unevaluated step is equivalent to the preceding step, then the earliest unevaluated step is identified as correct. Alternatively, if it is determined that the earliest unevaluated step is non-equivalent to the preceding step, then the earliest unevaluated step is identified as incorrect.

If it is determined that the earliest unevaluated step is correct, then the process 700 proceeds to block 714 wherein the second component of the math engine, also referred to herein as the rules engine, is applied to the earliest unevaluated step. In some embodiments, the rules engine can determine whether the earliest unevaluated step can be further simplified and/or further transformed, as indicated a decision state 716. If the earliest unevaluated step cannot be further simplified and/or further transformed, then the process 700 proceeds to block 718 and the last step is marked as correct.

Returning again to decision state 712, if the earliest unevaluated step is determined to be incorrect, then the process 700 proceeds to block 720 wherein the earliest unevaluated step is marked as incorrect. After this step is marked as incorrect, or alternatively, returning to decision state 716, if it is determined that the earliest unevaluated step is subject to further transformation, then the process 700 proceeds to block 722 wherein the rules engine is triggered. At block 724, the rules engine can iteratively evaluate rules to identify a valid rule and/or rule path for further transformation of the earliest unevaluated step. In some embodiments, this can include selecting one or several rules, applying those were several rules to the earliest unevaluated step to generate a next step, and the evaluation of the generated next step with the math engine, and specifically with the computer algebra system to determine the correctness of the next step.

This selecting applying one or several rules can be performed until a valid rule and/or rule path is identified. As used herein, a rule path is valid when transformations caused by the rule path are correct and lead to a final answer. Once a valid rule path is identified, the process proceeds to block 726 when a rule for the next step is identified. This rule for the next step is the first rule in the valid rule path. This identified rule can be used to generate the next step and/or a hint as indicated in block 728. In some embodiments, the next step and/or hint can be generated by identifying a code or token associated with the rule, and identifying hint text associated with the code or token. This hint text can be stored in the database server 104. Alternatively, in some embodiments, the code or token associated with the role can be ingested into machine learning model train to generate text, and specifically trained to generate hint text. The machine learning model can output the hint, and the next step and/or hint can be provided to the user as indicated in block 730.

Returning again to decision state 710, if it is determined that the earliest unevaluated step is not a last step, then the process 700 proceeds to block 732 wherein the computer algebra system is applied to determine the correctness of the earliest unevaluated step. As discussed above, this can include determining the equivalence of the earliest unevaluated step with one or several preceding steps, and specifically with the step preceding the earliest unevaluated step. As indicated at decision state 734, if it is determined that the earliest unevaluated step is equivalent to one or several preceding steps, and therefore is correct, then the process 700 proceeds to block 736 wherein the earliest unevaluated step is marked as correct, after which, the process 700 can return to block 708 and can proceed as outlined above.

Returning again to decision state 734, if it is determined that the earliest unevaluated step is incorrect, then the process proceeds to block 738 wherein the earliest unevaluated step is marked as incorrect. After the earliest unevaluated step is marked as incorrect, the process 700 proceeds to block 740 wherein the rules engine is triggered. At block 742, the rules engine can iteratively evaluate rules to identify a valid rule and/or rule path for further transformation of the earliest unevaluated step. In some embodiments, this can include selecting one or several rules, applying those were several rules to the earliest unevaluated step to generate a next step, and the evaluation of the generated next step with the math engine, and specifically with the computer algebra system to determine the correctness of the next step.

This selecting and applying one or several rules can be performed until a valid rule and/or rule path is identified. As used herein, a rule path is valid when transformations caused by the rule path are correct and lead to a final answer. Once a valid rule path is identified, the process proceeds to block 744 wherein a rule for the next step is identified. This rule for the next step is the first rule in the valid rule path. This identified rule can be used to generate the next step and/or a hint as indicated in block 746. In some embodiments, a next step and/or hint can be generated by identifying a code or token associated with the rule, and identifying hint content associated with the code or token. In some embodiments, the hint content can comprise hint text associated with the code or token, a hint indicator of where in an expression to apply the rule, and/or hint text and an indicator of the where in the expression to apply the rule. In some embodiments, the hint indicator can show where in the expression to apply the rule via, for example, a graphic such as an arrow, a changing of an aspect of the font of the portion of the expression to which the rule is to be applied, or the. This hint text can be stored in the database server 104. Alternatively, in some embodiments, the code or token associated with the role can be ingested into machine learning model train to generate text, and specifically trained to generate hint text. The machine learning model can output the hint, and the next step and/or hint can be provided to the user as indicated in block 748. After the next step and/or hint has been provided, the process 700 can return to block 708 and proceed as outlined above.

With reference now to FIG. 16, flowchart illustrating one embodiment of a process 760 for rule-based next step generation is shown. The process can be performed by all or portions of the system 100 including, for example, the processor 102. The process 760 begins at block 762 wherein the last correct step in the response received from a user is identified. In some embodiments, this last correct step can be identified at the time of the evaluation of the last correct step and/or at the time of marking of the last correct step as correct. The last correct step can be identified by the processor 102.

At block 766 one or several expression trees for the identified last correct step are received and/or retrieved. In some embodiments, and as discussed with respect to FIG. 15, two expression trees can be generated for each step. In such an embodiment, two expression trees can be retrieved and/or received at block 766. In some embodiments in which a single expression tree is received and/or retrieved, the single received and/or retrieved expression tree can comprise the second expression tree for the identified last correct step.

After the expression tree has been received and/or retrieved, the process 760 proceeds to block 768 wherein the expression tree is evaluated. In some embodiments, the evaluation of the expression tree can include the generation of features from the expression tree, which features can be based off the tokens at the nodes of the expression tree and/or rules associated with the nodes of the expression tree. At block 770 a pattern in the expression tree is identified. In some embodiments, the identification of a pattern within the expression tree can include the ingestion of all or portions of the expression tree and/or the ingestion of features generated from the expression tree into a machine learning model. The machine learning model can identify one or several patterns in the expression tree and can, based on those one or several patterns identify and/or select one or several relevant rules and/or one or several relevant rule sets as indicated in block 772.

A hierarchy for the selected one or several relevant rules and/or one or several relevant rule sets can be determined as indicated in block 774. In some embodiments, this hierarchy can be set based on heuristics associated with the selected one or several relevant rules and/or the one or several selected relevant rule sets. The server 102 can apply the heuristics to the selected one or several relevant rules and/or the one or several selected relevant rule sets to determine a hierarchy of the rules and/or rule sets.

Based on the hierarchy determined in block 774, a rule can be selected as indicated in block 776. In some embodiments, the selected rule can be the highest-ranking rule in the rule hierarchy. After a rule has been selected, the process 760 proceeds to block 778 wherein the selected rule is applied to the last correct step to generate a potential next step. In some embodiments, the application of the rule to the last correct step can include the transformation of the last correct step according to the rule to generate the potential next step. The rule can be applied to the last correct step by the server 102.

After the potential next up is been generated, the process 760 proceeds to block 780 wherein the equivalence of the potential next step is evaluated. In some embodiments, the equivalence of the potential next step to the last correct step can be evaluated by the math engine, and specifically by the computer algebra system. As indicated at decision state 782, if it is determined that the potential next step is not equivalent to the last correct step, and the process 760 proceeds to block 784 wherein the next rule in the rule hierarchy is identified, and the process 760 proceeds to block 776 wherein that next rule is selected. From block 776, the process 760 proceeds as outlined above.

Returning again to decision state 782, if it is determined that the potential next step is equivalent to the last correct step, then the process proceeds to block 786 where the applied rule is identified. In some embodiments, this can include identifying a code or token associated with the applied rule. At block 788, the user profile of the user from which the responses received is updated. In some embodiments, the user profile is updated based on the applied rule and/or the code or token associated with the applied rule. In some embodiments, the user profile is updated to reflect non-mastery of the applied rule and/or coder token associated with the applied rule. In the event that one or several steps provided by the user are correct, rules used in generating correct steps can be applied, and the user profile can be updated to reflect mastery of those rules. The updating of the user profile can include the updating of the database server 104 and specifically the user profile database 301 by the server 102.

At block 790 the next step can be provided. In some embodiments, the next step can be provided to the user device 106 from the server 102. The user device 106 can then provide the next step to the user via, for example, the I/O subsystem 526.

With reference now to FIG. 17, a flowchart illustrating one embodiment of a process 800 for automatic conversion of image data into computer readable text is shown. The process 800 can be performed by all or portions of the system 100 including by processor 102. The process 800 begins at block 802 wherein response image data is received. In some embodiments, the response image city can be received by the server 102 from the user device 106.

At block 804 the image is ingested into a machine learning model. In some embodiments, for image data comprising a plurality of steps in a response, step 804 can include ingesting the image into a bounding box model. The bounding box model can create bounding boxes with location coordinates around each line and/or step in the response. Step 804 can further include preprocessing of the image such as, for example, modifying the size of the image and/or one or several attributes of the image such as, for example, converting the image to grayscale if the image is a color image, modifying the contrast and/or brightness of the image, or the like. In some embodiments, the one or several attributes of the image and/or the size of the image are modified to achieve a desired image size and/or desired image attributes.

In some embodiments, the machine learning model can be trained to generate one or several outputs, which outputs can be received at block 806, and which outputs can include one or several candidate boxes and candidate label. A candidate box can be a bounding box around individual characters in the response image, and the candidate label can be a token characterizing the contents of the candidate box. Each of the candidate boxes, defines an area and location, and the candidate label defines a token. In some embodiments, the candidate label can further include a confidence score, which confidence score characterizes the estimated accuracy of the output of the machine learning model.

In some embodiments, the machine learning model can be trained to identify the size (area) and location of one or several regions in the image data. In some embodiments, the machine learning model can be further trained to, for each area, identify a token based on the contents of that area, and generate a confidence score characterizing the confidence that the area, location, and token are correct. In some embodiments, the machine learning model can generate one or several overlapping or at least partially overlapping areas and/or can identify a plurality of tokens for an area.

In some embodiments, the machine learning model can predict that a single character in the response image may be multiple different characters. For example, the machine learning model may predict that a character in the response image may be a “2” or a “z.” The machine learning model may provide a confidence score for each of these predictions such as, for example, “2”-95% and “z”-5%.

In some embodiments, the machine learning model may generate and/or output one or several competing candidate boxes. In some embodiments, the step of block 808 can include identifying competing candidate boxes and combining competing candidate boxes into a single box. In some embodiments, the server can be configured to identify boxes as competing when the overlap of the boxes exceeds a threshold value. In some embodiments, for competing candidate boxes, step 808 can include the creation of a single candidate box comprising a weighted aggregate of all competing candidate boxes for one character in the response image, and the creation of a single candidate label based on the weighted aggregate of all competing candidate labels for the one character in the response image.

In some embodiments, the step of block 808 can further include the combination of a plurality of candidate boxes. In some embodiments, this can include the applying of a speller to the rank-ordered competing candidate boxes. In some embodiments, this speller can affect the ordering of the rank-ordered competing candidate boxes. The speller can evaluate the tokens of overlapping candidate boxes and see of the combination of tokens of those overlapping candidate boxes matches a math term. For example, overlapping boxes may include “c,” “o,” and “s.” The speller can determine that these relate to a known math term, e.g. “cos” and can combine these candidate boxes to form a single candidate box with a token for “cos.” More specifically, in some embodiments, this can include the identifying of one or several target candidate boxes and/or target areas. The target candidate box can represent a potential math term. Candidate boxes can be compared to the one or several target candidate boxes to identifying candidate boxes and/or areas overlapping and/or partially overlapping the target candidate boxes and/or target areas. For each target area, each overlapping candidate box is evaluated to determine whether the token of that overlapping box corresponds to an attribute of the target candidate box, or alternatively, if a prediction for the target box corresponds to a prediction for the overlapping candidate box. If the predictions and/or token/attributes for the target candidate box and the overlapping candidate box match, then the confidence score for the target candidate box is increased and the confidence score for the overlapping candidate box is decreased. Alternatively, if the predictions and/or token/attributes for the target candidate box and the overlapping candidate box do not match, then the confidence score for the target candidate box is decreased and the confidence score for the overlapping candidate box is increased.

At block 810, a computer readable character string, such as a LaTeX character string is generated. This can include the conversion of candidate boxes into a computer readable character string such as, a LaTeX String. In some embodiments, this can include ingesting candidate boxes and labels into the decoder, which decoder can recursively process the candidate boxes. This processing can use locations of the candidate boxes to reorder the boxes into a desired sequence and the inserting of invisible tokens such as, for example, ‘A’ and curly brackets.

At block 812, the computer readable character string, and/or a representation of the computer readable character string is provided to the user. In some embodiments, this can include providing the computer readable character string from the processor 102 to the user device 106, which user device can display the computer readable character string to the user via the I/O subsystem 526. At block 814, user feedback is received at the processor 102 from the user device 106, and specifically from the I/O subsystem 526. The user feedback can identify one or several portions of the computer readable character string as correct or incorrect.

At decision state 816, it is determined if all or portions of the computer readable character string are correct. This determination can be made based on the feedback received in block 814. If it is determined that all or portions of the computer readable character string are incorrect, then the process 800 proceeds to blocks 818 through 822. In some embodiments, at block 818 through 822 user inputs correcting the computer readable character string and/or identifying a correct computer readable character string are received. At block 818 one or several alternative character strings are identified and/or are outputted. In some embodiments, these one or several alternative character strings can be identified based on confidence scores. In some embodiments, the computer readable character string outputted in block 812 can be the computer readable character string having the highest confidence level. In block 818, computer readable character strings having lower confidence levels can be identified and output to the user.

At block 820 user inputs identifying the correct computer readable character string are received. At block 822, the computer readable character string is updated based on the inputs received in block 820. At block 824, the models used in generating the computer readable character string are updated based on the incorrect provided computer readable character string and the subsequently identified correct computer readable character string.

After the computer readable character string is updated in block 822, or returning to decision state 816, if it is determined that the computer readable character string outputted in block 812 is correct, the process 800 proceeds to block 826 and provides the computer readable character string for use by the math engine or by other methods or processes disclosed herein. In some embodiments, the step of block 826 can further include the storing of the computer readable character string in the database server 104, and specifically in the content library database 303.

With reference now to FIG. 18, a flowchart illustrating one embodiment of a process 830 for location prediction within a knowledge graph is shown. The process 830 can be performed by all or portions of the system 100 including, for example, the processor 102. The passes 830 can be performed to determine the location of a problem or a response to a problem in the knowledge graph. The process 830 begins at block 832 wherein an input is received. In some embodiments, the input can comprise a problem, and some embodiments, the received input can comprise response data. At block 834 the received input is converted into a computer readable string. This conversion can occur according to process 800 of FIG. 17.

A block 836 the computer readable string is parsed, and at block 838 an expression tree for the received input is generated. In some embodiments, the expression tree can comprise the first expression tree characterizing variables and operations in the received input, and in some embodiments, the expression tree comprises a second expression tree characterizing rules applicable to the received input and/or to solve the received input. In some embodiments, the first expression tree of a step can be created by ingesting the received input into the math engine and specifically into the computer algebra system. The computer algebra system can output the first expression tree. Nodes associated with operations in the first expression tree can be identified and tokenized. The second expression tree can be created by the replacement of nodes indicative of operations in the first expression tree with tokens, and, in some embodiments, the second expression tree can be stored in an adjacency matrix. The expression trees can be generated by the server 102 and specifically by the math engine of the server 102.

At block 840 one or several features are generated from the expression tree. In some embodiments the features can be generated from the first expression tree, from the second expression tree, or from a combination of the first and second expression trees. In some embodiments, the features from the expression tree comprise the expression tree, and generating features from the expression tree can comprise putting the expression tree in a format ingestible into a machine learning model. In some embodiments, generating features from the expression tree can include identifying nodes in the expression tree and tokenizing the nodes contained in the expression tree, or alternatively, identifying nodes in the expression tree and receiving tokens representing the identified nodes. The generating of feature can further include generating a matrix representing the tokenized nodes contained in the expression tree. The one or several features can be generated by the server 102.

At block 842, the features are ingested in to the machine learning model. In some embodiments, the machine learning model can be trained to identify a location in the knowledge graph based on ingested features. At block 844, the model outputs are received, and at block 846, the location in the knowledge graph is identified based on the model outputs. At block 848, content is provided to the user. In some embodiments, providing content to the user includes selecting content based on a combination of the users attributes, which can be determined based on the user profile in the profile database 301, and the identified location in the knowledge graph.

With reference now to FIG. 19, a flowchart illustrating one embodiment of a process 850 for generating a correct next step is shown. The process 850 can be performed by all or portions of the system 100 including the processor 102. The process 850 begins at step 852, wherein the preceding step, or in other words, wherein the last evaluated step and/or wherein the last correct step is identified. At block 854, the next step in the response is received and/or identified. At block 856 the next step is evaluated, and it is determined that the next step is incorrect. In some embodiments, this can include evaluation of the next step with the computer algebra system and in some embodiments this can include determining, with the computer algebra system, that the next step is not mathematically equivalent to the last step identified in block 852.

The process 850 proceeds to block 858 and returns to the last step identified in block 852. At block 860, at least one expression tree is received and/or is generated for the last step. In some embodiments, a pair of expression trees is generated for the last step as a part of the evaluation of the last step. In such an embodiment, the pair of expression trees can be stored in the database server 104 and one or both of the expression trees can be received and/or retrieved in block 860. Alternatively, one or both of the expression trees can be generated, as described elsewhere herein, as part of the step of block 860.

At block 862, a rule group for solving of the last step is identified. In some embodiments, this rule group can be identified based on the expression tree and/or based on features generated from the expression tree. In some embodiments, the rule group can be determined based on the application of heuristics to the expression tree, and in some embodiments, the rule group can be determined based on one or several patterns identified in the expression tree. In some embodiments, the identification of a pattern within the expression tree can include the ingestion of all or portions of the expression tree and/or the ingestion of features generated from the expression tree into a machine learning model. The machine learning model can identify one or several patterns in the expression tree and can, based on those one or several patterns identify and/or select one or several relevant rule groups.

After the rule group has been determined, the process 850 proceeds to block 864, wherein a rule path is selected and applied. In some embodiments, the rule path can be selected according to a rule hierarchy. The rule hierarchy can be determined based on heuristics associated with the relevant rule group. The server 102 can apply the heuristics to the selected one or several relevant rules and/or the one or several selected relevant rule sets to determine a hierarchy of the rules and/or rule sets. Based on the hierarchy of rules, a rule path can be selected. The selected rule is applied to the last step to generate a potential next step. In some embodiments, the application of the rule to the last step can include the transformation of the last step according to the rule to generate the potential next step. The rule can be applied to the last step by the server 102.

After the rule path has been applied and the potential next up has been generated, the process 850 proceeds to block 866 wherein the equivalence of the potential next step is evaluated. In some embodiments, the equivalence of the potential next step to the last correct step can be evaluated by the math engine, and specifically by the computer algebra system. As indicated at decision state 868, if it is determined that the potential next step is not equivalent to the last correct step, and the process 850 proceeds to decision state 870, wherein it is determined if there is an additional rule path in the rule group determined in block 862. If there is not additional rule path, then the process 850 returns to block 862 and proceeds as outlined above. Alternatively, if it is determined that there is an additional rule path, then the process 850 proceeds to block 872, wherein the next rule path is identified and selected. In some embodiments, identifying and selecting the next rule path includes identifying the next rule path in the rule hierarchy, and then selecting this next rule path. After the next rule path has been selected, the process 850 returns to block 864 and continues as outlined above.

Returning again to decision state 868, if it is determined that the potential next step is equivalent to the last step, then the process 850 proceeds to block 874 and identifies the first rule in the rule path as the next step. In some embodiments, identifying the first rule in the rule path can include identifying the code and/or token associated with the first rule in the rule path. At block 876, a hint and/or content associated with the next step is identified. In some embodiments, the hint and/or content associated with the next step can be identified with the code or token associated with the rule. In some embodiments, the hint and/or the content associated with the next step can be stored in the database server 104, and this hint and/or content associated with the next step can be identified and/or retrieved by querying the database server 104 with the code and/or token. Alternatively, in some embodiments, the code or token associated with the rule can be ingested into machine learning model train trained to generate text, and specifically trained to generate hint text and/or content associated with the next step. As indicated in block 878, the hint and/or content associated with the next step can be provided to the user.

With reference now to FIG. 20, a flowchart illustrating one embodiment of a process 900 for automated indeterminate prompt resolution is shown. In some embodiments the process 900 can be performed to generate sufficient metadata for a problem and/or receive response data to allow evaluation of the received response data. The process 900 can be performed by all or portions of the system 100 including the processor 102.

The process begins at block 902 wherein response data is received. In some embodiments, the response data can comprise image data capturing a multi-step response. The response can be received by the server 102 from the user device 106 and/or from the database server 104 and specifically from the user profile database 301. After the response it has been received, the process 900 proceeds block 904 wherein the response data is converted to a computer readable character string. This conversion can, in some embodiments, take place according to some or all of the steps of process 800 of FIG. 17.

After the computer readable character string has been generated, the process 900 proceeds block 906 wherein an expression tree is generated. In some embodiments, the expression tree can be generated for some or all of the steps in the multi-step response. In some embodiments, the expression tree can be generated for the first step in the multi-step response. The generation of the expression tree can include the generation of the first expression tree or the generation of the first expression tree and the second expression tree. The expression tree can be generated as discussed above.

After the expression tree is been generated, the process 900 proceeds block 908 wherein the computer readable character string, the expression tree, and/or any associated metadata is evaluated for ambiguity. In some embodiments, this ambiguity indicates the inability of the processor 102 to determine the desired course of action for solving the problem. For example, a single string of characters such as, y=x²+2x−5−(2(6x−1)), may be used to teach, evaluate, and/or test a variety of skills. For example, a student may simplify, integrate, or take the derivative of that string of characters. While the response data may indicate a correct manipulation of a character string, this manipulation of the character string may be undesired. For example, a problem may call for a student to simplify a string of characters, but the response data may show the correct integration of that character string. The system 100 having only received the character string, the response data, or both the character string and the response data is unable to determine how to evaluate the response data as the information in the character string and/or the response data is insufficient to indicate the overarching task that is to be performed on the character string by the student. In other words, the problem and/or the response data may be ambiguous.

In some embodiments, the evaluation for ambiguity can include evaluating the computer readable character string, the expression tree, and/or any associated metadata for information indicating the overarching task to be performed by the student. A decision state 910, it is determined if the overarching task to be performed by the student is ambiguous. The overarching task to be performed by the student is ambiguous if the evaluating of the computer readable character string, the expression tree, and/or any associated metadata fails to provide sufficient indicators of the overarching task to be performed by the student.

If it is determined that the overarching task to be performed by the student is ambiguous, then the process 900 proceeds to block 912 for a goal clarification is triggered. Goal clarification can, in some embodiments, be triggered based on an attribute of the expression tree. In some embodiments, goal clarification can include one or several steps used to identify the overarching task to be completed by the student. These steps can include interaction with the student together information indicating the overarching task to be completed by the student.

After goal clarification has been triggered, the process 900 proceeds block 914 wherein a goal, or in other words, the overarching task to be performed by the student is identified. In some embodiments, the overarching test to be performed with a student can be identified via interaction with the student, and specifically the other providing the student with one or several questions and the receiving of responses to those one or several questions. In some embodiments, for example, the triggering of goal clarification can cause the processor 102 to direct the user device 106 to provide one or several questions to the student and receive responses to those questions. In some embodiments, these questions can ask whether the student should simplify, integrate, take the derivative, solving for variable, or the like. Based on the student response to these questions, one or several following questions may be asked. For example, if the student indicates that the overarching task is integration, the processor 102 can direct the user device to query the student indicate whether the integral is definite or indefinite, and if the integral is definite, the lower and upper bounds of the integral. Similarly, for example, if the student indicates that the overarching task is to take a derivative, the processor 102 can direct the user device 106 to query the student to indicate with respect to what the derivative should be taken. Similarly, for example, if the student indicates that the overarching task is to solve for a variable, the processor 102 can direct the user device 106 to query the student to identify the variable to be solved for.

As soon responses are received, metadata can be generated, as indicated in block 916, for the received response and/or for the problem associated with the received response. This metadata can reflect the answers and/or information provided by the student. The metadata can be linked with the received response and/or the promise associated with the received response and can be provided to the math engine.

After the metadata has been provided to the math engine, or returning to decision state 910, if it is determined that there is no ambiguity with respect to the overarching task to be performed by the student, then the process 900 proceeds to block 920 wherein unevaluated steps are selected, to block 922 wherein the correctness of selected steps is evaluated, and to block 924 where the finality of some or all of the selected steps is evaluated. In some embodiments, the correctness of a step can be determined by determining that the step is mathematically equivalent to a preceding step. In some embodiments, this evaluation is performed based on the metadata generated in block 916. In some embodiments, steps 920 through 924 represent iteratively: identifying of steps in the response; selection of an unevaluated step in the response; and evaluation of that selected step to determine the correctness of steps in the response and/or the correctness of the response. This iterative process can be performed until all of the steps in the response have been evaluated, or until an incorrect step in the response has been identified.

A decision state 926 it is determined if the step is incorrect. This determination can be made based on the result of the evaluation of step 922 and/or of step 924. If it is determined that the step is correct, then the process 900 proceeds to block 928 wherein the step is marked as correct. Alternatively, if it is determined at decision state 926 that the step is incorrect, then the process 900 proceeds to block 930 wherein the step is marked as incorrect and the process 900 and proceeds to block 932 wherein the next step and/or hint is generated and provided to the student.

At block 934 the user profile of the student is updated. In some embodiments, the user profile the student can be updated based on the result of the evaluation of blocks 922 and block 924. In some embodiments, the user profile is updated based on incorrect steps provided by the student. In some embodiments, the user profile can be updated based on the generated next step and/or can't. In such an embodiment, the user profile can be updated based on the rule used in generating the next step and/or hint. In some embodiments, the user profile is updated to reflect non-mastery of the rule used in generating the next step and/or can't. The updating of the user profile can include the updating of the database server 104 and specifically the user profile database 301 by the server 102.

With reference now to FIG. 21, flowchart illustrating one embodiment of the process 940 for reinforcement learning-based content recommendation is shown. The process 940 can be performed to identify and provide content to a student and to use data indicative of the effectiveness of the provided content to improve future content identification. The process 940 can be performed by all or portions of the system 100 including by processor 102. The process 940 begins at block 942 wherein a request for content is received. In some embodiments, the request for content can include an identifier of the user requesting content. In some embodiments, the request for content can be received by the server 102 from the user device 106.

At block 944 a user profile of the user requesting content is received and/or retrieved. The user profile can be received by the processor 102 from the database server 104 and specifically from the user profile database 301. In some embodiments, the server 102 can query the database server 104, and specifically the user profile database 301 for the user profile, in response to which the database server 104 can provide the user profile to the server 102.

At block 946 a target bin of the user is identified. In some embodiments, the target bin is identified according to one or several attributes of the user, which attributes of the user are found in the user profile. These attributes can include, for example, one or several user skill levels, preferences, abilities, learning styles, or the like. In some embodiments, the target bin can comprise data indicative of content provided to one or several similarly situated users previously, and the result and/or effectiveness of that provided content.

After the target bin has been identified, the process 940 proceeds to block 948 wherein the target bin is received. In some embodiments, the receipt of the target bin includes the receipt of information relating to the target bin in the data stored in the target bin. The target bin can be stored in the database server 104 and specifically in the content library database 303. In some embodiments, after the target bin has been identified, the processor 102 can query the database server 104 for information relating to the target bin. In response to this query, the database server 104 can provide information relating to the contents of the target bin, which information can be received by the processor 102.

After the target bin has been received, the process 940 proceeds to block 950 wherein windowing is applied. In some embodiments, windowing expands the data set beyond the target bin to one or several adjacent bins to create a sufficiently large and/or sufficiently complete data set to improve content recommendation. The application of windowing includes determining the number of adjacent bins to include within the window, the retrieving of data from each of those adjacent bins, and the weighting of data from those adjacent bins. In some embodiments, the number of adjacent bins included in the window, or in other words, the width of the window varies based on the amount of data contained in the target bin. Specifically, as the amount of data in the target bin increases the number of adjacent bins included in the window, or in other words the width of the window, decreases. Similarly, as the amount of data in the target bin increases the effect on the content recommendation of data in the adjacent bins, or in other words, the importance of data in adjacent bins in the content recommendation, decreases. This decrease in a fact is controlled via a weighting value that decreases as the amount of content in the target bin increases. Thus, applying the window includes determining the amount of content in the target bin, determining the width of the window based on the amount of content in the target bin, and determining the weighting value based on the amount of content in the target bin. With width of the window in the weighting value determined, data from the target bin and the adjacent bins in the window is gathered and the weighting value is applied.

Based on the windowing, a sampling algorithm is applied to select content for recommendation as indicated in block 952. In some embodiments, the sampling algorithm can provide a combination of exploration and exploitation of content available for providing to users to allow continuous learning and/or identification of best content for providing to users. This exploration and exploitation, in combination with the steps of block 960 and 962, below, enable constant improvement of content recommendations by process 940 based on reinforcement learning. In some embodiments, the sampling algorithm can select content based in part on the passed effectiveness of that content. In some embodiments, the sampling algorithm can generate a list of potential items for presentation, which list can be rank ordered. In some embodiments, the sampling algorithm can comprise Thompson sampling. The sampling algorithm can be applied by the processor 102.

After the sampling algorithm has been applied, the process 940 proceeds to block 954, wherein boosting is applied. In some embodiments, the boosting can affect the rank order of potential items in the list of potential items for presentation. In some embodiments, the boosting can affect the rank order of potential items in the list of potential items for presentation according to one or several user preferences of the user to which the content is being provided. In some embodiments, for example, boosting can affect the rank ordering based on the users favorite content type. In some embodiments, applying boosting includes determining whether sufficient data has been gathered for the user to enable boosting, calculating boosting values if sufficient data has been gathered to enable boosting, applying the boosting values to the results of the sampling algorithm, and reordering the list of potential items for presentation according to the application the boosting values to the results of the sampling algorithm.

After the application of boosting, the process 940 proceeds to block 956 when one or several items are selected and returned. In some embodiments, the one or several items are selected according to the rank ordering of the list of potential items for presentation. Thus in some embodiments in which a single item is selected and returned, the top item in the list of potential items for presentation is selected. Similarly embodiments in which x-number of items are selected for presentation, the top x-number of items in the rank-ordered list of potential items for presentation are selected.

After the items are selected for presentation, these items can be provided to the user. In some embodiments, the present evidence of user can include the retrieving of content associated with the items from the database server 104 and specifically from the content library database 303 and the providing of this content to the user device 106. In some embodiments, user device 106 can render this content and provide this content to the user via the I/O subsystem 526.

At block 958 user action data is received. In some embodiments, the user action data can be received by the server 102 from the user device 106. This user action information can include, for example, information indicative of the user's interaction with the content such as, for example, whether the user accessed the recommended content, the amount of time spent on content, the quality of the user's interactions with the content, or the like. In some embodiments, user action data can further indicate whether, and the degree to which the user took action subsequent to receipt of the content. Specifically, the user action data can indicate whether the user was inspired by the content to try again, or specifically to try to solve another problem and/or another step to a problem. In some embodiments, the user action data can further characterize any improvement caused by the content, or in other words, any change to a user skill level relevant to the provided content subsequent to receipt of the content. In some embodiments, this change in the user skill level can be determined based on whether the user correctly or incorrectly responded to one or several problems are steps after receipt of the content.

After receipt of the user action data, the process 940 proceeds to block 960 when recommendation success is determined. In some embodiments the determination of the recommendation success is based on the received user action data. In some embodiments, this can include the calculation of value characterizing degree to which the user interact with the content, a value characterizing the degree to which the content inspired the user to take further action, and a value characterizing the degree to which the content affected the user skill level. Each of these values can be modified according to a discount rate which discount rate reflects the decay rate. In some embodiments, for example, in which multiple pieces of content are provided to the user the discount rate can discount the value of the selection of content based on the order in which one or several pieces of content were selected by the user. Thus the first selected piece of content would be less effected by the discount rate than the last selected piece of content. In some embodiments, the discount rate may reflect a time-based decay, thus the value characterizing the degree to which the content inspired further action and/or the value characterizing the degree to which the content affected the user skill level is diminished by the discount rate as the length of time between the user's consumption of the provided content and the further action or the user's consumption of the provided content and the change in skill level increases. After application of the discount rate to the values for a piece of content, the modified values can be combined to generate a reward value for a piece of provided content. In some embodiments, the value can be combined via, for example, the adding of the values to generate a sum.

After the recommendation success has been determined, the target bin data can be updated based on the success of the recommendation. Specifically, the data for the recommended content can be updated based on the success of the recommendation determined in block 960. In some embodiments, this update can be performed in the database server 104, and specifically in the content library database 303. After the updating of the target bin data for the recommended content, the process can return to block 942 once a new content request is received.

Reference out FIG. 22, flowchart illustrate one embodiment of a process for hybrid content evaluation is shown. The process can be performed by all or portions of the system 100 including the processor 102. The process 1000 begins at block 2, wherein a computer readable responses received. In some embodiments, computer readable response can be received as the output of process 800 of FIG. 17. After the computer readable responses received, the process 1000 proceeds to block 4 wherein associated metadata is received. In some embodiments, the associated metadata can be received as the output of goal clarification which can be according to steps 912 through 918 of process 900 shown in FIG. 20.

At block 6, expression trees can be generated for the readable response. In some embodiments, the generation of expression trees can include the generation of a pair of expression trees for each step in the payload of the readable response, or in other words the generation of a pair of expression trees for each step in the readable response. In some embodiments, this pair of expression trees can include the first expression tree and the second expression tree described elsewhere herein.

After the expression trees have been generated, the process 1000 proceeds to step 8 wherein the first expression trees are sent to the math engine and specifically to the computer algebra system. A decision state 10, a first step in the readable response is evaluated by the math engine and specifically by the computer after a system to determine if the first step is valid math. In some embodiments, the determination of whether the first up is valid math can provide a check on the accuracy of the readable response. If it is determined that the first step is not valid math, then the process 1000 proceeds to step 12, wherein the user is prompted to fix step one of the readable response. After user input has been received fixing step one, the process 1000 updates the readable response based on the user inputs and/or generated a new readable response based on the user inputs. The process 1000 then returns to step 2 and proceeds as outlined above.

Returning again to decision state 10, if it is determined that step one is valid math, then the process 1000 proceeds to blocks 14 and 42. At block 14, the payload of the readable response, or in other word the steps of the readable response are sent to the math engine for step level evaluation of correctness. In some embodiments, this step level evaluation of correctness includes a determination of whether each step is equivalent, or more specifically is mathematically equivalent, to a preceding step. In some embodiments, this evaluation is iteratively performed by selecting the earliest unevaluated step, determining the equivalence of that earliest unevaluated step to a preceding step, and marking that earliest unevaluated step as either correct or incorrect based on the equivalence of that earliest unevaluated step to the preceding step. This iterative approach is indicated by decision state 16 wherein the equivalence of a selected step with a preceding step is determined. In some embodiments, this includes determining the equivalence of the selected step with the first step in a provided response, and in some embodiments, this includes determining the equivalence of the selected step with a preceding step that has been identified as correct such as, for example, an immediately preceding step determined as correct. If it is determined that the earliest unevaluated step is equivalent to the preceding step, then the earliest unevaluated step is marked as correct as indicated in block 18, which is then outputted to the user device 106 via the API is indicated in block 20.

After the step is marked correct at block 18, the process 1000 returns to block 16 and selects a new earliest unevaluated step and evaluates that new earliest unevaluated step. This iteration is performed until all of the steps have been evaluated and marked as correct, or alternatively until one of the steps is identified as incorrect or as non-equivalent.

Returning again to decision state 16, if it is determined that the earliest unevaluated step is not equivalent to a preceding step, then the process 1000 proceeds to block 22 wherein the earliest unevaluated step is marked as incorrect. After the step has been marked as incorrect, the process 1000 proceeds to block 24 wherein the second expression tree for the preceding step is retrieved. At block 26 the second portion of the math engine, or in other words the rules engine is triggered. The rules engine identifies one or several rule groups or rules for potential application to the preceding step to determine a correct next step.

At block 28 one or several rules relevant to the preceding step are identified. In some embodiments, these rules can be identified in the same or similar manner as discussed in blocks 768 through 772 of process 760 of FIG. 16.

At block 30, a rule and/or a rule path is selected for applying to the preceding step. In some embodiments, this can correspond to step 776 of process 760 of FIG. 16. After the rule or rule path is selected, this rule and/or rule path is applied to the preceding step. As a result of this application, a potential next step can be generated, which can be in the form of the generation a second expression tree for the potential next step. As indicated in block 34, this generated second expression tree can be converted into an expression tree of the first type. At decision state 36, the math engine can evaluate the equivalence of the potential next step to the preceding step via the evaluation of the first expression tree generated in block 34. If the potential next step is not equivalent to the preceding step, then the process 1000 returns to block 30 and selects a next rule and/or rule path.

Returning again to decision state 36, if it is determined that the potential next step is equivalent to the preceding step, then the rule or rule path used to generate that potential next step is identified as valid and the process 1000 proceeds to step 38 wherein the next step and/or a hint is generated. In some embodiments, this can include identification of the code or token associated with the valid rule. This code or token can be used to identify a hint and/or to generate a hint as disclosed above. Similarly, the next step can be generated by application of the valid rule to the preceding step. Alternatively, the generation of the next step can include the conversion of the expression tree of the first type into a character string for output to the user. After the next step and/or the hint have been generated, the process 1000 proceeds to block 40 wherein the next step and/or that hint are provided to the user. In some embodiments, this can include the output of the next step and/or hint via the API as indicated in block 20.

Returning again to decision state 10, if it is determined that the first step in the response is valid math, the process can proceed to block 42 wherein the payload of the response is sent for finality evaluation. At block 44 steps in the payload are evaluated for finality. In some embodiments this can include identifying a number of last steps in the payload for finality evaluation. In some embodiments, this number of last steps in the payload can include the last step in the payload, the last two steps in the payload, the last three steps in the payload, or the last four steps in the payload.

At decision state 46 it is determined if the last steps in the payload identified for finality evaluation are in a final state, or in other words, are in their most simplified form. In some embodiments, this can include determining if at least one or several of the last steps in the payloads meets at least one finality criterion. In some embodiments, this determination can be made by the first portion of the math engine, and specifically by the computer algebra system. If it is determined that none of the last steps in the payload are in the most simplified form, then the steps can be marked as non-final. In some embodiments, this marking as non-final can be output via the API at block 20. Alternatively, if one of the last steps in the payload is in the most simplified form than the step can be marked as final as indicated in block 48, which marking as final can be output via the API at block 20.

If the computer algebra system cannot determine if the last steps of the payload are in the most simplified form, then the process 1000 proceeds to block 50 wherein the second expression tree for each of the last steps in the payload is retrieved and/or generated. At block 52 the rules engine is triggered. At block 54 rules relevant to the step are identified in a similar manner to that discussed in block 28. A heuristic is applied to these rules resulting in a hierarchy or rules. In some embodiments, this heuristic can be a hard-coded heuristic, and in some embodiments, this heuristic can be determined based on a machine learning technique as discussed above in steps 768 through 772 of process 760 of FIG. 16. Based on this hierarchy a rule or rule path is selected and applied to the last step in the response which results in the generation of a permutation of the last response and the generation of an associated second type of expression tree. This can be repeated for some or all of the potential applicable rules or rule paths to generate one or several potential permutations and a second type of expression trees associated with each of the one or several potential permutations.

For each of these potential permutations, a first type of expression tree is generated as indicated in block 58. This can include the conversion of the second type of expression tree for each of the potential permutations to a first type of expression tree. At decision state 60, each of these permutations is evaluated to determine if it meets at least one finality criterion, or in some embodiments, if it is in the most simplified form. This evaluation can be similar to the evaluation of decision state 46. If it is determined that one of the permutations is final, then the process returns to block 48, marks the last step in the response as final, and outputs this marking via the API at block 20. If none of the permutations is final, then this is output via the API at block 20. If this evaluation at decision state 60 is inconclusive, then the process 1000 can return to block 50 and repeat steps 50 through 60 until all potential rule and/or rule paths are exhausted, until a permutation meeting finality criterion is identified, or until the last step is identified as non-final.

With reference now to FIG. 23, a flowchart illustrating one embodiment of a process 1001 for automated content recommendation is shown. In some embodiments, the process 1001 can include the automated generation of a machine learning model configured to make content recommendations. This machine learning model can, in some embodiments, utilize reinforcement learning. The process 100 can be performed by all or portions of the CDN 100.

The process 1001 begins at block 1002 with configuration step. In some embodiments, the configuration step can include requesting and receiving configuration information from the user for whom machine learning model is been created and/or configured. This configuration information can include information specifying one or several attributes of the model being created. This can include one or several attributes affecting the training of the model, and these inputs can include information specifying inputs to be received by the model which inputs can comprise one or several variables characterizing one or several attributes of a student, also referred to herein as an interaction user, who is interacting with machine learning model to receive one or several content recommendations. In some embodiments, these one or several attributes of the student can include, for example, one or several skill levels, identification of previously completed and/or received content, demographic information including, for example, age, grade, or the like, location information including city, state, region, county, district, or the like, and/or one or several learning styles and/or learning preferences. In some embodiments, the configuration step can further include receiving information identifying one or several outputs of the machine learning model.

At block 1004 a simulation step is performed. In some embodiments, the simulation step can include identifying one or several states within each of the variables identified in the configuration step, determining and/or generating correlation values characterizing correlation between the states within each of some or all of the variables identified in the configuration step, and generating correlation matrices containing the correlation values. In some embodiments, the process 1001 can loop from block 1004 back to 1002. In some embodiments, this looping can facilitate refinement of configuration choices and/or configuration inputs. This can include changing the number of states of one or several variables and/or changing the correlation between some or all of these states. At block 1006 a recommendation step is performed. In this step, information relating to an interaction user received, and based on that information, one or several pieces of content are recommended and/or one or several content recommendations are made.

At block 1008 an update step is performed. In some embodiments, this can include receiving information characterizing one or several interaction user interactions with the recommended content. In some embodiments, this can include information indicating whether the interaction user acted on the content recommendation and if so, whether that content recommendation was successful in achieving a desired outcome. Based on the success or failure of the content recommendation in achieving the desired outcome, success data associated with that recommended content and the context of the interaction user can be updated. In some embodiments, this can further include updating one or several correlation values based on the success or failure of the content recommendation in achieving the desired outcome. In some embodiments, the step of block 1008 can further include the steps of block 958 and 960 of FIG. 21.

At block 1010 performance information can be outputted. This can include, for example, outputting an indicator to the interaction user and/or to the user indicating the success and/or failure rates of the recommendations made in various contexts to different types of interaction users. In some embodiments, after performing the step of block 1010, the process can loop back to block 1004 and update one or several correlation values and/or generate further content recommendations as the CDN 100 interacts with further interaction users.

With reference now to FIG. 24, a flowchart illustrating one embodiment of a process 1020 for performing a configuration step is shown. The process 1020 can be performed as a part of, or in the place of the step of block 1002. The process 1020 begins at block 1022 wherein the user is identified. In some embodiments, this user can comprise the user who is interacting with the CDN 100 to create a machine learning model that will be used for content recommendation. This user can comprise, for example, a teacher instructor who is setting up a machine learning model for use with students and the teacher's class for content recommendations.

In some embodiments, the user can be identified via a login process whereby the user enters one or several user credentials to access the system. These credentials can include, for example, a username, password, or the like. In some embodiments, the identification of the user can include receiving the user credentials and identifying a user profile associated with those credentials. This profile can identify, for example, one or several attributes of the user, one or several user preferences, one or several attributes or expected attributes of interaction uses associated with the user such as, for example, one or several attributes expected attributes of the teacher's students, or the like.

After the user is identified, the process 1020 proceeds to block 1024 wherein model input information is requested and received. This model input information can be requested and received by the server 102 of the CDN 100 from the user via a device such as the user device 106 and/or the supervisor device 110. In some embodiments, the model input information can identify one or several inputs to be ingested by the machine learning models to provide content recommendations. These inputs can relate to one or several attributes of the interaction user for whom content is being recommended including, for example, one or several skill levels and/or proficiency levels, one or several locations, an age, or the like.

These inputs can comprise one or several variables which variables can be, for example, ordinal, hierarchical, or independent. Each of the variables can comprise a plurality of states. In some embodiments, the relationship between the states can determine the type of variable. For example an independent variable, as used herein, can be a variable having states that are unrelated to each other, in other words that are independent and uncorrelated to each other. An ordinal variable can be a variable having a plurality of states that are non-hierarchically related to each other in some kind of series or sequence. This can include, for example, a skill level. A hierarchical variable can have a plurality of states that are hierarchically related to each other. An example of this could be a geographical location where within a higher-level geographic location (e.g., a state) can be several lower level geographic locations (e.g., a county, a city, a neighborhood, etc.). In some embodiments, such a hierarchy can have a plurality of leaf nodes that are the ultimate children of a hierarchical directed graph. These leaf nodes can be children of one or several parent nodes that can represent latent variables, whereas the leaf nodes represent observed variables. In some embodiments, these hierarchical relationships can comprise an ontology, wherein observed variables comprise categories that are not further subdivided; in other words, they are the most granular of categories in the ontology. Regardless of the exact structure of the hierarchy, correlation values are assigned to each parent node in the hierarchy, specifying the expected correlations between every pair of that parent's children. Hierarchical variables can be used as inputs in the machine learning model and/or are outputs from the machine learning model.

At block 1026 model output information is requested and received. The output information can be requested and received by the server 102 of the CDN 100 from the user via a device such as the user device 106 and/or the supervisor device 110. In some embodiments, the output information can identify one or several desired outputs of the model, including, for example, identifying one or several predications and/or recommendations or prediction type and/or recommendation type to be generated and output by the model. In some embodiments, this can include identifying and/or inputting content that can be recommended to the interaction user by the model. In some embodiments, these outputs can comprise any type of variable including, for example, one or several ordinal variables, one or several hierarchical variables, and/or one or several independent variables. This content can comprise, for example, remediation content which can include, for example, remediation content such as text, audio, and/or video content explaining and/or discussing a topic, one or several hints, one or several activities, or the like.

With reference to the FIG. 25, a flowchart illustrating one embodiment of a process 1040 for generating correlation matrices is shown. The process 1040 can be performed as a part of, or in the place of the step of block 1004. In some embodiments, the process 1040 can include the generation of one or several correlation matrices based on information received as part of a configuration step 1002. The process 1040 begins at block 1042 wherein correlation data is received for some or all of the ordinal and/or hierarchical variables received in block 1024 and/or block 1026. In some embodiments, this correlation data can comprise the user's estimate of correlation between states in these variables.

At block 1044, a variable type is determined for each of variables received in block 1001 reform block 1026. If a variable is identified as an independent variable, then a simplified correlation matrix can be generated for the independent variable, which simplified correlation matrix can comprise an identity matrix. After generation of a correlation matrix, a next variable for which a correlation matrix has not been generated can be selected. If a variable is not an independent variable, or in other words, is either an ordinal variable or hierarchical variable, than the process 1040 proceeds to decision step 1046 where it is determined if the variable is an ordinal variable.

If the variable is an ordinal variable, then the process 1040 proceeds to block 1046 where kernel values are generated for each pair of states in the ordinal variable. In some embodiments, the kernel values can be generated by use of a kernel function such as, for example, the kernel functions typically used with support vector machines and/or Gaussian processes. In some embodiments, the kernel function can comprise a radial basis function configured to reflect the degree of correlation or smoothness specified by the user.

After the kernel values of been generated, the process 1040 proceeds to block 1048 wherein a correlation matrix is formed. In some embodiments, the correlation matrix can have a size that corresponds to the number of outcome pair combinations for the variable of the correlation matrix. Thus, for example, a variable having eight states can have a correlation matrix of size 8×8, or, for example, a variable having 10 states can have a correlation matrix of size 10×10. At block 1050, the correlation matrix is populated with the kernel values generated in block 1046.

Returning again to decision step 1046, if it is determined that variable is not an ordinal variable, then the process 1040 proceeds to block 1052 wherein hierarchies within the hierarchical variable are identified. In some embodiments, this can include identifying hierarchical relationships and latent variables that connect the various states within the hierarchical variable. In some embodiments, these hierarchies can be identified based on information received during the configuration of block 1002. In some embodiments, identification of the hierarchy of the variable can include identifying relationships between some or all of the states of the variable, such as, for example, identifying first-cousins, first-cousins-once-removed, second-cousins, second-cousins-once-removed, third-cousins, etc. by specifying the latent parent nodes that connect all of the observed states via a latent hierarchy of nodes.

At block 1054, the correlation values between all sets of sibling nodes in the hierarchy can be received. In some embodiments, this can include receiving correlation data received in block 1042 and applying it to each set of sibling nodes in the hierarchy. In some embodiments, each of the individual sibling nodes can be either a parent node with children of its own or a terminal, leaf node with no children. In some embodiments, these correlation values link sibling nodes that share a common parent node, regardless of whether the child nodes are themselves latent parent nodes or terminal leaf nodes representing observed states. These sibling or child nodes can be located at any level in the hierarchy (except for root nodes), including at the leaf level. In some embodiments, after correlation values have been applied to all the parent nodes in the hierarchy, every sibling node on the tree will be linked to all of its other direct siblings via a correlation value.

At block 1056 correlation values linking leaf nodes are calculated for some or all of potential pairings between all the leaf nodes and all the other leaf nodes. In some embodiments, these leaf node correlations can be calculated via path analysis. In some embodiments, path analysis can include tracing the path connecting a pair of leaf nodes and generating a correlation value for the pair of leaf nodes by multiplying the correlations connecting each pair of nodes along the traced path, including any parent nodes representing any latent variables. In some embodiments, a user could directly provide some or all of the pairwise correlations between leaf states in the hierarchical variable. In such an embodiment, these values could be directly populated into a correlation matrix for the variable, and any missing correlation values could be generated via path analysis and user-provided correlations between sibling nodes.

After the correlations between the leaf nodes have been calculated, the process 1040 proceeds to block 1058 wherein a correlation matrix for the variable is populated with the leaf node correlations calculated in block 1056.

After the population of the correlation matrix in either block 1050 or block 1058, the process 1040 proceeds to block 1060 wherein the generated correlation matrix is stored. In some embodiments, the correlation matrix can be stored in memory accessible by the server 102 such as, for example, the database server 104. After the correlation matrix has been stored, it can be determined if there are other variables for which a correlation matrix has not been generated. If there are variables for which a correlation matrix has not been generated, then one of those remaining variables can be selected and process 1040 can be repeated. Process 1040 can be repeated until a correlation matrix has been generated for all of the variables.

With reference now to FIG. 26, a flowchart illustrating one embodiment of a process 1070 the content recommendation is shown. The process 1070 can be performed as a part of, or in the place of the step of block 1006 of FIG. 23. The process 1070 begins at block 1072 wherein an interaction user request is received. In some embodiments, this request can be received from the student via the user device 106 the server 102 in some embodiments, this request can comprise a request for content recommendation such as, for example, a recommendation for supplemental content such as the media content.

At block 1074 a user context for the requesting user of block 1072 is determined and/or formed. In some embodiments, this can include determining the context of the student requesting content, or in other words determining a plurality of attributes of the student requesting the content. In some embodiments, this determination can be made by requesting information about the interaction user from the database server 104, and specifically from the user profile database. This information can identify, for example, one or several skill levels or proficiencies of the interaction user, location information relevant to the interaction user, identification of previous content consumed by the interaction user, one or several learning styles and/or learning preferences of the interaction user, or the like.

At block 1076 correlation matrices relevant to the user context are retrieved. These correlation matrices can be retrieved from the memory accessible by the server 102 in which the correlation matrices were stored in block 1060 of FIG. 25. In some embodiments, the retrieving of correlation matrices relevant to the user context can include identifying information relevant to the interaction user and the corresponding correlation matrices to that information. These corresponding correlation matrices can then be retrieved.

At block 1078 the retrieved correlation matrices can be aggregated with each other. In some embodiments, this aggregation of the matrices can comprise a multiplication of the correlation matrices, or specifically the multiplication of relevant columns of the correlation matrices. In some embodiments, this aggregation can be performed by the server 102 via any desired matrix modification algorithm. This aggregation of the correlation matrices can result in the generation of a set of scalar weights. This set of scalar weights can have the same dimensionality as a data set used to determine the user context. In some embodiments, each of the correlation matrices can represent a variable orthogonal to the variables represented by others of the correlation matrices. Thus the set of scalar weights can have the same dimensionality as the some of the number of correlation matrices that are aggregated. In some embodiments, the set of scalar weights can include a scalar weight relevant to every potential combination of every variable state (including both context/input variables and recommendation/output variables).

At block 1082 success and failure data is identified for each potential recommendation in each potential context. Thus, for each piece of content that could be recommended and/or for each recommendation that could be made, success and failure data is identified for each potential context. In some embodiments, for example, previous recommendations have been made to users in multiple of the potential user contexts. As these recommendations have been made, the success or failure of those recommendations have been tracked and have been associated with the context of the user to which the recommendation was made. In block 1082, this historic data tracking the success or failures of past recommendations in the different contexts is retrieved. This success and failure data can be retrieved from the database server 104, or as discussed below, may be locally stored in the node making the recommendation.

At block 1084, each of the success and failure data for each potential recommendation in each potential context is multiplied by the scalar weight, from the set of scalar weights, for that context. This results in the generation of a weighted success value and a weighted failure value for each potential recommendation in each context. This multiplication of the scalar weight by the success and failure data for each recommendation in each context scales the success and failure data for each potential recommendation in each context based on the correlation between that context and the user context. Through this scaling, a larger set of data is able to be used in making the content recommendation, specifically, data relevant to contexts other than the user context is scaled and is then usable in making a content recommendation for the interaction user.

At block 1086 some of scaled success data and scaled failure data for each of the potential recommendations is generated. In some embodiments, this can include identifying scaled success data for each potential recommendation in each potential context and calculating the sum of that scaled success data, and identifying scaled failure data for each potential recommendation in each potential context and calculating the sum of that scaled failure data.

At block 1088, a sampling algorithm is applied to select content for recommendation. In some embodiments, the sampling algorithm can be applied to some success and failure data for each potential recommendation. In some embodiments, the sampling algorithm can select content based in part on the past effectiveness of that content. In some embodiments, the sampling algorithm can generate a list of potential items for presentation, which list can be rank ordered. In some embodiments, the sampling algorithm can comprise Thompson sampling. The sampling algorithm can be applied by the processor 102. In some embodiments, the step of block 1088 can further include the steps of blocks 954 and 956 of FIG. 21.

In some embodiments, the sampling algorithm can provide a combination of exploration of content previously untried in that particular context and exploitation of content already known to be successful in that context, allowing for continuous learning and/or identification of the best, personalized content for each interaction user. This exploration and exploitation, in combination with the step of block 1008 enables constant improvement of content recommendations by process 1001 based on reinforcement learning.

With reference now to FIG. 27, a schematic illustration of one embodiment of an architecture 1100 for performing the automated content recommendation of process 1001 is shown. As seen in FIG. 27, interaction user interface with the server 102 to make recommendation requests as shown in 1102. These requests are received via a load balancer 1104 which can distribute the received requests to one of a plurality of nodes 1106. Each of these nodes can comprise a compute instance that can perform one or several processing requests. IN the embodiment of FIG. 27, these compute instances can execute the process of FIGS. 23 through 26 to generate a recommendation with the machine learning model. In some embodiments, the compute instance of each of the nodes can comprise a virtual compute instance such as, for example, a virtual machine, a container, or the like, and in some embodiments, the compute instance of each of the nodes can comprise a hardware component such as a bare metal machine.

Each of the compute instances 1106 can include a memory 1108 and a recommend API 1110. In some embodiments, the memory 1108 can include the correlation matrices and the success and failure data, can include some aggregated representations of that data, for some or all of the potential context. In some embodiments, the memory 1108 can include the machine learning model. In some embodiments, the recommend API 1110 can access the memory 1108 and can generate a recommendation. In some embodiments, this can include recommending content and/or generating a rank ordered list of potential content.

Each node 1106 can further interact with the user to determine whether the user interaction with the recommend content and result of that recommendation. Each node can then generate an update to the success and failure data based on this user interaction with recommended content and the result of that recommendation. Each node can communicate this update to a pub/sub 1116 which can gather the update information and deliver a digest of updates according to a subscription model to the nodes. In some embodiments, the pub/sub can operate according to a push model wherein the pub/sub pushes the digest of updates when it is available to send, or according to a pull model where the subscriber pulls (requests) the digest when the subscriber is ready to receive the digest. Thus, as seen in FIG. 27, a first node 1106-A receives updates via a first subscription 1118 and the second node 1106-B receives updates via a second subscription 1120.

Updates from the nodes can further be stored in a master memory 1114, which master memory can contain a database comprising a complete copy of the configuration, which can include the correlation matrices, a database comprising a complete copy of all success and failure data, and aggregated representations of the data. This master memory 1114 can be useful in creating new nodes in that the memory 1108 of the new node 1106 can be created from the master memory 1114 by generating a copy of the database comprising a complete copy of the configuration and correlation matrices in the memory 1108 of the new node 1106 and by generating a copy of the success and failure data in the memory 1108 of the new node 1106.

With reference now to FIGS. 28 through 31, a flowchart illustrating one embodiment of a process 1200 for automated OCR database generation. This process 1200 can be performed by all or portions of CDN 100. This process 1200 can include identifying and/or receiving a plurality of seeds. These seeds can be used to generate new expressions by having a Math Engine swap out different numbers and tokens in the expressions. These new expressions can be cleaned, and augmentations are added that make the expressions look like realistic handwriting. Some basic augmentations include changing the background to look like plain or lined paper, changing the ink color, and changing the thickness of different characters. In some embodiments, this can include starting with, for example, 6400 seeds compiled from one or several sources of expressions. These seeds can be used to generate new expressions, which expressions can be cleaned and receive added augmentations to make the expressions resemble handwriting.

Adding more detail, the process 1200 can include a plurality of major processes, including, for example, synthetic data creation 1201, expression cleaning 1207, rendering 1223, and TFrecord creation 1241. In some embodiments, synthetic data creation 1207 can include the creation of a large number of character strings, which character strings can correspond to a large number of expression such as math expressions.

In some embodiments, expression cleaning can ensure that the character strings comprise one or several desired attributes. In embodiments in which a character string corresponds to an expression, and specifically corresponds to a math expression, expression cleaning can include determining if the expressions, and specifically if the math expressions are valid math. In some embodiments, expression cleaning can further include adding specifications for rendering.

In some embodiments, rendering can include the creating of one or several images and/or metadata for each of the expressions. In some embodiments, TFrecord creation can include the creation of TFrecords, which TFrecords can, in some embodiments, speed up model training when using a machine learning platform such as, for example, TensorFlow.

In some embodiments, synthetic data creation can include receiving one or several seeds as inputs as indicated in block 1203. Each of these seeds can be, in some embodiments, a math expression. Upon receiving the seeds, synthetic data creation can include the steps of, duplicating the seeds 1202, creating expression trees from the seeds 1204, and pruning and permuting the created expressions as indicated in block 1206. Duplicating seeds can include creating and/or taking a list of seeds. These seeds can be one or several expressions such as math expression which are relevant to a desired set of generated data. For example, if the desired set of generated data is relevant to Limits, these seeds only contain Limits expressions. Thus, the resulting data will be in the scope of Limits, for example. These seeds can be duplicated by any desired factor including, for example, a factor of: 5, 10, 50, 100, 500, 1000, 5000, 10000, 50000, 100000, 500000, 1000000, 5000000, 10000000, or any other or intermediate number.

Creating expression trees from seeds can include, for example, using the functionality imported from the Math Engine to convert the expression string to an expression tree representation. In some embodiments, pruning, and permuting expressions can include: Randomly truncating, collapsing, swapping out like-tokens to create unique expressions.

Expression cleaning as indicated in block 1207 can include, removing invalid expressions and/or invalid permutations as indicated in block 1208, run expressions through the math engine as indicated in block 1210 to validate expressions, remove invalid expression trees as indicated in block 1212, insert decorators as indicated in block 1214, and apply different color as indicated in block 1222. Removing invalid expressions can include, conducting various regex checks for proper formatting, math structure, and latex structure. Running expressions through the Math Engine can include using the Math Engine 1211 to parse expression to expression tree and back to ensure it is properly formatted. This can be a stricter check than performed in removing invalid expressions. Removing invalid expression trees can include the removing of any expressions that fail upon being run through the Math Engine 1211.

Inserting decorators can include: Taking a Font which is either created from manual collection and cleaning as indicated in block 1216 or “harvested” from live images as indicated in block 1220, and decorating the expression specifying the font. This decorating of the expression specifying the font can add additional information in the latex beyond the math expression itself. Applying different color can include specifying that each token has a certain RGB value that is one value different per token. In some embodiments, this can enable automatically knowing which pixels belong of which token.

Rendering as indicated in block 1223 can include identifying pixels as indicated in block 1224, applying uniform ink color as indicated in block 1226, rendering base image as indicated in block 1228, imposing background image as indicated in block 1230, applying visual augmentations as indicated in block 1234, and organizing metadata as indicated in block 1238. Identifying pixels can include using the colors specified in applying the different colors, to render an image and automatically separate all pixels of every token. This supports (i) bounding boxes, record the 4-pixel coordinates of all tokens and (ii) masks, record binary yes/no for each pixel in the image if it is part of the token or not. Repeat for all tokens. Applying uniform ink color can include removing the color specifications applied in the step of applying different colors and replacing the specification with the ink color desired for the final image.

Rendering the base image can include rendering the latex in the font and color specified. Imposing background image can include imposing the base image on images of a plurality of different types of backgrounds, including on a plurality of different types of paper. Applying visual augmentations can include modifying the image qualities through image augmentation techniques. Organizing metadata can include gathering bounding boxes, masks, latex, and all augmentation information.

Creating TFrecords as indicated in block 1241 can include writing TFrecords. This specifically can include writing TFrecords as indicated in block 1242 and saving the TFrecords as indicated in block 1244. In some embodiments, these TFrecords can be saved to the cloud.

With reference now to FIG. 32, a flowchart illustrating one embodiment of process 1260 for OCR training is shown. The process 1260 can be performed by all or portions of the CDN 100. The process 1260 begins at block 1262 with the synthetic data generation pipeline. This can include the processes shown in FIGS. 28-31. At block 1264, the OCR model is trained. In some embodiments, the OCR model can be trained using the data generated in block 1262. The model is evaluated in block 1266. If the model is determined to be inadequately trained, then the process 1260 can return to blocks 1262 and 1264 for further data generation and further training.

If it is determined that the model is sufficiently trained, the process 1260 proceeds to block 1268, wherein the model is deployed. At block 1270, a user submits an image for analysis. This image can be an image of a response or of one or several steps in a response. At block 1272, the model generates a predication as to the content of the image, and specifically of the math of the image. In some embodiments, this step can be performed as outlined in FIG. 17. After the model prediction, the user can continue to use the app as indicated in block 1274, and as indicated in block 1276, font information from the user image can be harvested. This font image can be fed into the synthetic data generation pipeline of block 1262 to generate further synthetic data.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method for reinforcement learning based content recommendation, the method comprising:
receiving configuration data for creation of a reinforcement learning model, the configuration data comprising a plurality of variables, each of the plurality of variables comprising a plurality of states;
generating a plurality of correlation matrices, wherein a correlation matrix is generated for each of at least a portion of the plurality of variables, and wherein the correlation matrix of one of the plurality of variables characterizes a correlation between the plurality of states of that one of the plurality of variables;
receiving a request for content for providing to a user;
determining a user context, the user context characterizing an aggregation of attributes of the user;
selecting a next piece of content from a database of pieces of content, wherein each piece of content is linked with a value characterizing an outcome of previous presentation of that piece of content, wherein the next piece of content is selected in part based on the value characterizing the outcome of previous presentation and on the user context and the correlation matrices;
presenting the selected piece of content to the user;
receiving user inputs in response to the presenting of the selected piece of content to the user; and
updating the value characterizing the outcome of previous presentation of the selected piece of content based on the received user input.

2. The method of claim 1, further comprising: receiving a user profile for the user, the user profile containing information defining a plurality of attributes; and determining the user context based on the received user profile.

3. The method of claim 1, wherein selecting the next piece of content comprises:
receiving the correlation matrices relevant to the user context;
multiplying the received correlation matrices to generate a set of scalar weights, wherein each of the scalar weights is associated with a context;
identifying success and failure data for each potential next piece of content in each potential context;
multiplying the success and failure data for each potential next piece of content in each potential context by the scalar weight for that context;
generating a sum of each of the weighted success data and failure data for each potential next piece of content; and
selecting the next piece of content based on the sums.

4. The method of claim 3, wherein selecting the next piece of content based on the sums comprises selecting one of a list of potential pieces of content for presentation according to a sampling algorithm.

5. The method of claim 4, wherein the sampling algorithm comprises a Thompson-sampling algorithm.

6. The method of claim 3, wherein selecting the next piece of content based on the sums comprises: generating rank ordered list of potential pieces of next content; and displaying the rank ordered list of potential pieces of next content to the user.

7. The method of claim 1, wherein generating the plurality of correlation matrices comprises:
selecting one of the plurality of variables;
determining a type of the selected one of the plurality of variables; and
generating correlation values for the selected one of the plurality of variables based on the type of the selected one of the plurality of variables.

8. The method of claim 7, wherein the type of the selected one of the plurality of variables comprises at least one of: an ordinal variable; and a hierarchical variable.

9. The method of claim 8, wherein, when the selected one of the plurality of variables comprises an ordinal variable, generating correlation values comprises:
identifying states within the selected variable;
forming pairs between the states within the selected variable; and
generating kernel values for each of the pairs between states within the selected variable.

10. The method of claim 9, further comprising populating a correlation matrix with the kernel values.

11. The method of claim 8, wherein, when the selected one of the plurality of variables comprises a hierarchical variable, generating correlation values comprises:
identifying a hierarchy of states within the selected one of the plurality of variables;
receiving correlation values between nodes in all parent levels in the hierarchy of states;
calculating leaf node correlations; and
populating the correlation matrix with the leaf node correlations.

12. The method of claim 11, wherein the leaf node correlations are calculated via path analysis.

13. A system for reinforcement learning based content recommendation, the system comprising:
a memory comprising a plurality of databases; and
at least one processor configured to:
receive configuration data for creation of a reinforcement learning model, the configuration data comprising a plurality of variables, each of the plurality of variables comprising a plurality of states;
generate a plurality of correlation matrices, wherein a correlation matrix is generated for each of at least a portion of the plurality of variables, and wherein the correlation matrix of one of the plurality of variables characterizes a correlation between the plurality of states of that one of the plurality of variables;
receive a request for content for providing to a user;
determine a user context, the user context characterizing an aggregation of attributes of the user;
select a next piece of content from a database of pieces of content, wherein each piece of content is linked with a value characterizing an outcome of previous presentation of that piece of content, wherein the next piece of content is selected in part based on the value characterizing the outcome of previous presentation and on the user context and the correlation matrices;
present the selected piece of content to the user;
receive user inputs in response to the presenting of the selected piece of content to the user; and
update the value characterizing the outcome of previous presentation of the selected piece of content based on the received user input.

14. The system of claim 13, wherein selecting the next piece of content comprises:
receiving the correlation matrices relevant to the user context;
multiplying the received correlation matrices to generate a set of scalar weights, wherein each of the scalar weights is associated with a context;
identifying success and failure data for each potential next piece of content in each potential context;
multiplying the success and failure data for each potential next piece of content in each potential context by the scalar weight for that context;
generating a sum of each of the weighted success data and failure data for each potential next piece of content; and
selecting the next piece of content based on the sums.

15. The system of claim 14, wherein selecting the next piece of content based on the sums comprises selecting one of a list of potential pieces of content for presentation according to a sampling algorithm.

16. The system of claim 15, wherein the sampling algorithm comprises a Thompson-sampling algorithm.

17. The system of claim 13, wherein generating the plurality of correlation matrices comprises:
selecting one of the plurality of variables;
determining a type of the selected one of the plurality of variables; and
generating correlation values for the selected one of the plurality of variables based on the type of the selected one of the plurality of variables, wherein the type of the selected one of the plurality of variables comprises at least one of: an ordinal variable; and a hierarchical variable.

18. The system of claim 17, wherein, when the selected one of the plurality of variables comprises an ordinal variable, generating correlation values comprises:
identifying states within the selected variable; forming pairs between the states within the selected variable;
generating kernel values for each of the pairs between states within the selected variable; and
populating a correlation matrix with the kernel values.

19. The system of claim 17, wherein, when the selected one of the plurality of variables comprises a hierarchical variable, generating correlation values comprises:
identifying a hierarchy of states within the selected one of the plurality of variables;
receiving correlation values between nodes in all parent levels in the hierarchy of states;
calculating leaf node correlations; and
populating the correlation matrix with the leaf node correlations.

20. The system of claim 19, wherein the leaf node correlations are calculated via path analysis.
